(19) United States
(12) Patent Application Publication
(10) Pub. No.: US 2025/0220687 A1
(43) Pub. Date: Jul. 3, 2025

(54) ENHANCED RESOURCE PARTITIONING FOR NEW RADIO (NR)-LONG TERM EVOLUTION (LTE) CO-EXISTENCE

(71) Applicant: Intel Corporation, Santa Clara, CA (US)

(72) Inventors: Salvatore Talarico, Santa Clara, CA (US); Gang Xiong, Portland, OR (US); Kilian Roth, Munich (DE); Sergey Panteleev, Kildare (IE)

(21) Appl. No.: 18/850,439

(22) PCT Filed: May 15, 2023
(86) PCT No.: PCT/US2023/066988

§ 371 Date: Sep. 24, 2024

Related U.S. Application Data
(60) Provisional application No. 63/356,163, filed on Jun. 28, 2022.
(60) Provisional application No. 63/410,559, filed on Sep. 27, 2022.

(51) Int. Cl. H04W 72/25; H04B 17/318; H04L 5/00

(52) U.S. Cl. CPC H04W 72/25; H04B 17/328; H04L 5/0005

(57) ABSTRACT

Various embodiments herein provide techniques related to a user equipment (UE). The UE may identify, by a long term evolution (LTE) sidelink (SL) module that is to facilitate communication via a first SL channel of a first cellular network, a resource that is to be used for communication in the first SL channel by another UE; provide, by the LTE SL module, information related to use of the resource to a new radio (NR) SL module that is to facilitate communication via a second SL channel of a second cellular network; and exclude, by the NR SL module based on the information related to use of the resource, the resource for communication via the second SL channel. Other embodiments may be described and/or claimed.

### CROSS REFERENCE TO RELATED APPLICATION

The present application claims priority to U.S. Provisional Patent Application No. 63/356,163, which was filed Jun. 28, 2022; and to U.S. Provisional Patent Application No. 63/410,559, which was filed Sep. 27, 2022.

### FIELD

Various embodiments generally may relate to the field of wireless communications. For example, some embodiments may relate to resource partitioning for cellular network co-existence.

### BACKGROUND

Various embodiments generally may relate to the field of wireless communications.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates an example of impact of one wireless network on another, in accordance with various embodiments.

FIG. 2 illustrates an alternative example of impact of one wireless network on another, in accordance with various embodiments.

FIG. 3 illustrates an alternative example of impact of one wireless network on another, in accordance with various embodiments.

FIGS. 4a and 4b (collectively, FIG. 4) illustrates examples of different wireless networks operating with different multiplexing modes, in accordance with various embodiments.

FIG. 5 schematically illustrates an example of semi-static frequency division multiplexing (FDM) with enabled hybrid automatic repeat request (HARQ) feedback for a new radio (NR) system, in accordance with various embodiments.

FIG. 6 illustrates examples of Type I and Type II resources, in accordance with various embodiments.

FIG. 7 illustrates an example of use of time division duplexing (TDD) between a long term evolution (LTE) network and NR sidelink (SL) transmissions, in accordance with various embodiments.

FIG. 8 illustrates an example of an enhanced inter-user equipment (UE) coordination scheme, in accordance with various embodiments.

FIG. 9 illustrates an alternative example of an enhanced inter-UE coordination scheme, in accordance with various embodiments.

FIG. 10 illustrates an alternative example of an enhanced inter-UE coordination scheme, in accordance with various embodiments.

FIG. 11 illustrates an example of a multi-slot configuration related to automatic gain control (AGC), in accordance with various embodiments.

FIG. 12 schematically illustrates an example wireless network in accordance with various embodiments.

FIG. 13 schematically illustrates example components of a wireless network in accordance with various embodiments.

FIG. 14 is a block diagram illustrating example components, according to some example embodiments, able to read instructions from a machine-readable or computer-readable medium (e.g., a non-transitory machine-readable storage medium) and perform any one or more of the methodologies discussed herein.

FIG. 15 illustrates an alternative example network in accordance with various embodiments.

FIG. 16 depicts an example procedure for practicing the various embodiments discussed herein.

FIG. 17 depicts another example procedure for practicing the various embodiments discussed herein.

FIG. 18 depicts another example procedure for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR may act as a unified network/system that meets vastly different and sometime conflicting performance dimensions and services. Such diverse multi-dimensional requirements may be driven by different services and applications.

For instance, in the third generation partnership project (3GPP) release-16 (which may be referred to herein as Rel.16, Rel-16, Rel. 16, etc.) specifications, sidelink (SL) communication was developed at least in part to support advanced vehicle-to-anything (V2X) applications. In the release-17 (referred to herein as Rel.17, Rel-17, Rel. 17, etc.) specifications, proximity-based services were introduced including public safety and commercial related services and as part of Rel.17, power saving solutions (e.g., partial sensing, discontinuous reception (DRX)) and inter-user equipment (UE) coordination have been developed at least in part to improve power consumption for battery limited terminals and reliability of SL transmissions. Although NR SL may have been initially applicable to V2X applications, there is growing interest in the industry to expand the applicability of NR SL to commercial use cases, such as sensor information (including video) sharing between vehicles with high degree of driving automation. For commercial SL applications, the two following elements may be desirable:
Increased SL data rate
Support of new carrier frequencies for SL

To achieve these aspects, objectives in the 3GPP release-18 (which may be referred to as Rel.18, Rel. 18, Rel-18, etc.) specifications may be at least in part to support SL carrier aggregation, SL over unlicensed spectrum, and also frequency range 2 (FR2 or FR-2, which may referred to transmissions at frequencies below approximately 7 gigahertz (GHz) or, in some embodiments, below approximately 6 GHz) SL operation. However, another aspect to consider is the V2X deployment scenario where both LTE V2X and NR V2X devices are to coexist in the same frequency channel. For the two different types of devices to coexist, while using a common carrier frequency, it may be desirable that there is/are mechanism(s) to efficiently utilize resource allocation by the two technologies without negatively impacting the operation of each technology. Furthermore, it may be desirable for these mechanisms to be designed so that no changes would be needed to the LTE design.

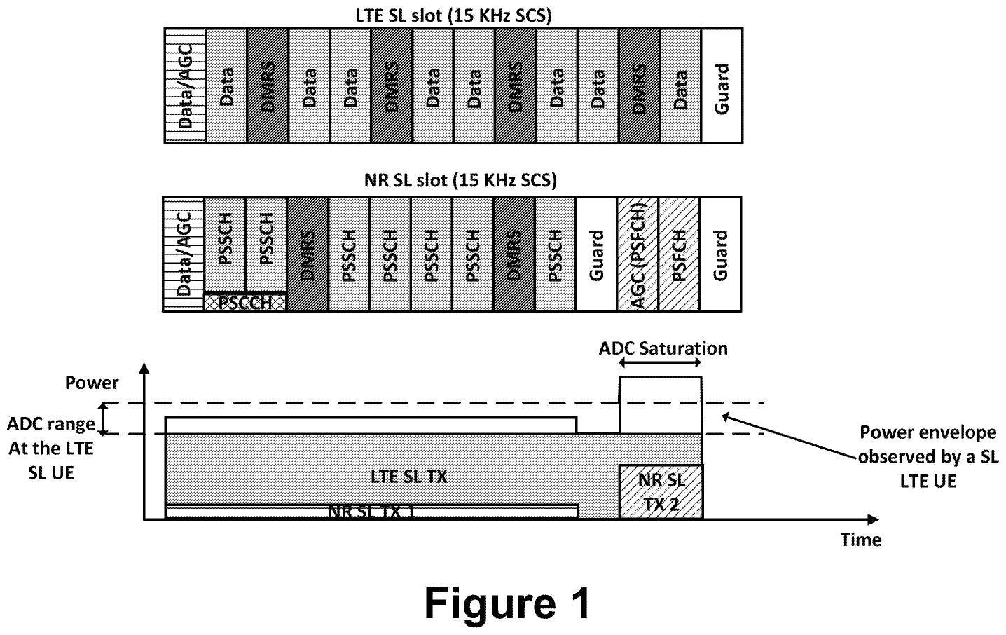

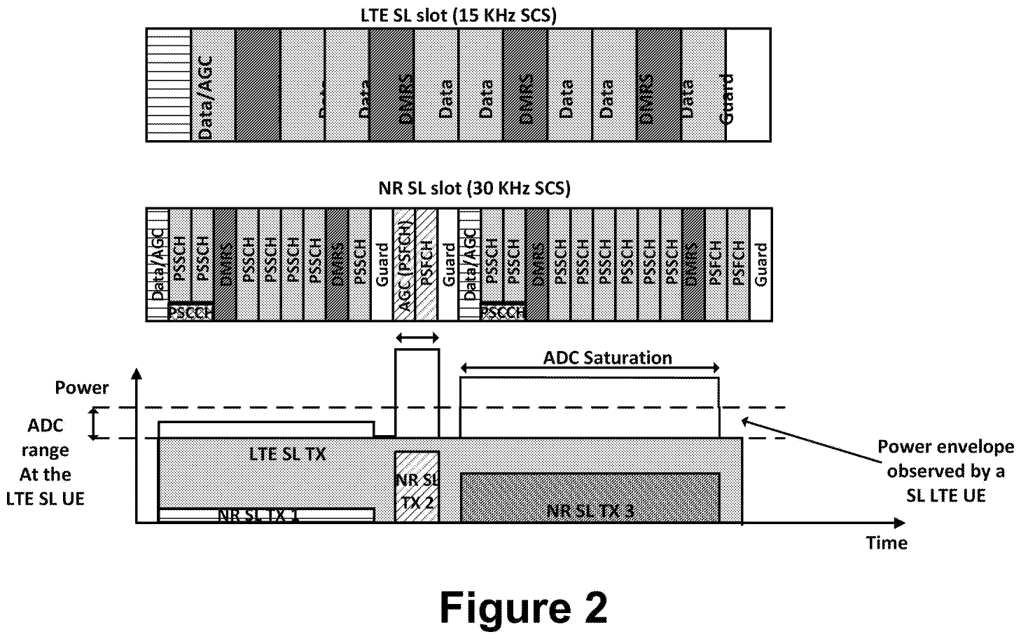

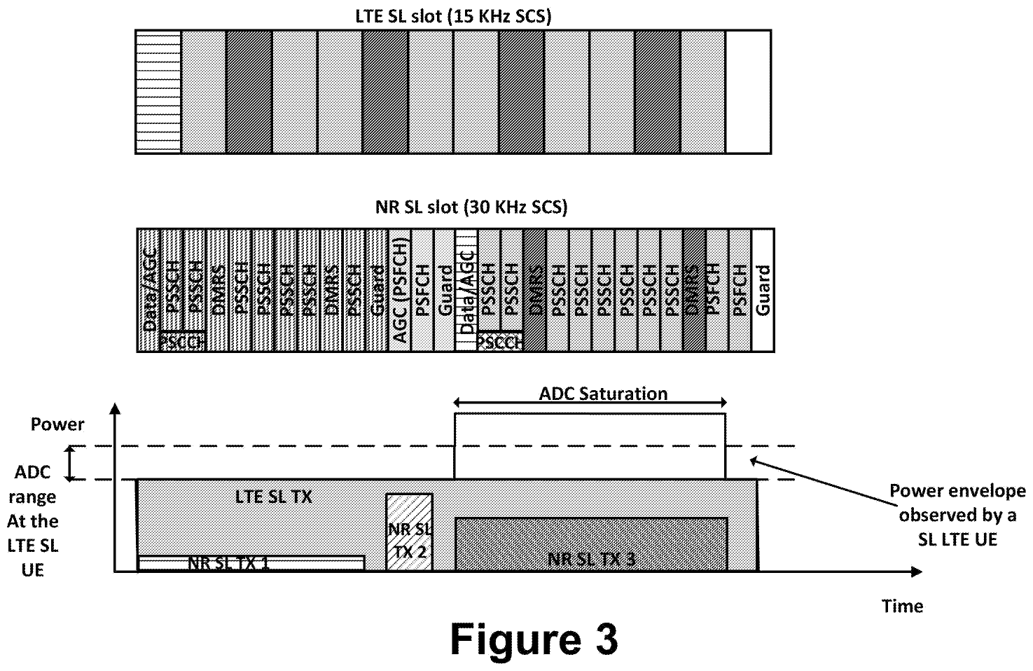

In this context, there are several challenges that may be considered when designing resource partitioning mechanisms for better co-existence among LTE V2X and NR V2X. The challenges may include, for example, one or more of the following:
1. Automatic gain control (AGC) impact deriving from the NR PSFCH transmission: Given that in NR, the physical SL feedback channel (PSFCH) has been introduced, the power variations associated with the NR V2X transmission in the case of NR-slots configured with PSFCH symbols may have a negative impact on the LTE's AGC setting due to the power envelope that an LTE device may observe during a subframe, as illustrated in FIG. 1. Specifically, FIG. 1 depicts an example of the impact of a NR transmission on an AGC related to LTE when the NR SL slot overlaps with the LTE SL subframe and contains PSFCH symbols. In fact, the LTE receiver (Rx) may perform the AGC adjustment in the first symbol of an LTE SL subframe and the AGC's gain may be adjusted based on the received signal power. When the NR UE performs PSFCH transmission in the second part of the subframe its signal will be added to the ongoing LTE SL transmission—which increases the total received power at the LTE Rx—while the AGC's gain determined in the first part of the subframe is still the one being applied. As a result, the above circumstance may lead the ADC to become saturated and therefore impact the decoding of the LTE transmission at the LTE Rx.
2. AGC impact deriving from using different subcarrier spacings (SCSs) between LTE and NR:
   a. Given that LTE and NR may use different SCS, regardless of whether an NR slot may or may not carry PSFCH symbols, the LTE's AGC setting may be detrimentally impacted due to the power envelope the LTE device may observe along the subframe, which may lead the LTE device to see high variations in terms of power along the subframe while being unable to cope with this variation, similarly as above. FIG. 2 illustrates an example of this issue, where NR SL supports 30 kilohertz (KHz) SCS and LTE SL supports 15 KHz SCS. In this example, the two NR V2X slots overlap with a LTE V2X subframe, and the first NR SL slot carries PSFCH, while the second does not.
   b. The same impact may be also observed in case NR V2X system may have nothing to transmit in a specific NR-slot as illustrated in FIG. 3. Specifically, FIG. 3 may depict an example of the impact of a NR transmission on an AGC related to LTE when the NR SL supports a different SCS than that of the LTE SL, and the NR SL will not or does not transmit in one of the two slots.
3. Non-ideal resource orthogonality between LTE and NR: regardless of whether LTE and NR may be configured to use same SCS and NR may or may not transmit PSFCH, given that LTE SL and NR SL are not able to indicate each other how the resources will be used, LTE and NR transmissions may collide with each other, and impact negatively the overall system performance. Notice that this issue may also arise even in case the resources devoted to LTE and NR may be configured to be orthogonal, if the subframe boundaries are not aligned between the two technologies due to synchronization errors.

With that said, embodiments herein may provide several options and design considerations on how to mitigate the aforementioned issues and improve the co-existence between NR and LTE.

One of the typical scenarios for V2X may include both LTE V2X and NR V2X devices, which need to coexist in the same frequency channel. For the two different types of devices to coexist, while using a common carrier frequency, it may be desirable that there is/are mechanism(s) to efficiently utilize resource allocation by the two technologies without negatively impacting the operation of each technology. Furthermore, these mechanisms should be envisioned and designed so that no changes would be needed to the LTE design. With that said, embodiments herein may provide several options and design considerations on how to improve the co-existence between NR V2X and LTE V2X when co-deployed.

### Semi-Static Resource Pool Partitioning

In one embodiment, LTE and NR V2X may be operated on orthogonal resources via higher layer signaling configuration (e.g., radio resource control (RRC) configuration), pre-configuration, or both, which can be semi-statically configured.

In particular, for NR V2X the IE SL-ResourcePool is used to configure the parameters of NR SL related to the resource pool, and:
For devices in coverage and RRC_CONNECTED state, the information element (IE) can be updated by SL-ConfigDedicatedNR within RRCReconfiguration;
For devices in coverage but in RRC_INACTIVE or RRC_IDLE state, the IE can be further updated by SIB12 within SystemInformation.

As for LTE V2X, the IE SL-CommResourcePoolV2X is the corresponding IE used to configure the parameters of LTE V2X related to the resource pool, and:
For devices in coverage and RRC_CONNECTED state, the IE can be updated by SL-CommConfig within RRCConnectionReconfiguration;
For devices in coverage but in RRC_IDLE state, it can be further updated by SystemInformationBlockType21 within SystemInformation.

As for pre-configuration, this may be updated by over-the-air signaling for one or both of a mobile equipment (ME, which may be similar to a UE) and/or a universal integrated circuit card (UICC).

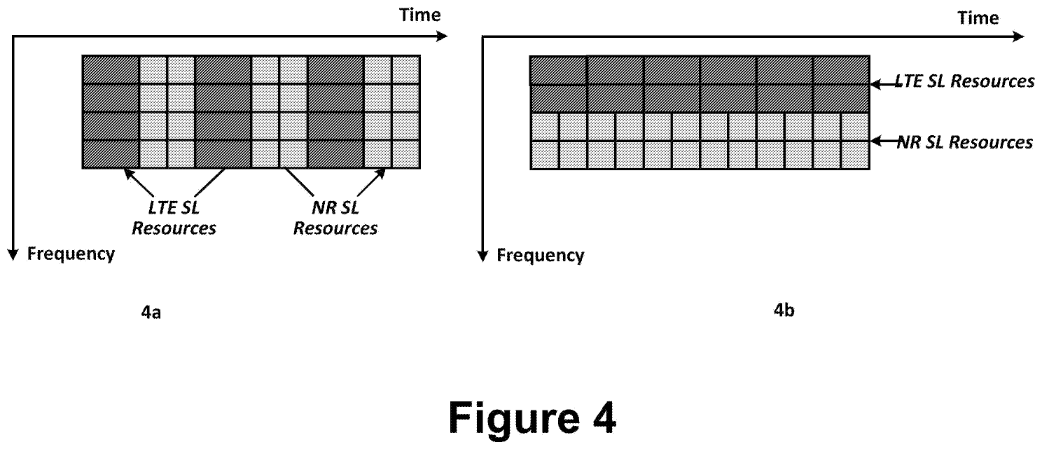

Using this approach, LTE V2X and NR V2X may be operated either in time division multiplex (TDM) or frequency division multiplexed (FDM) mode as illustrated in FIGS. 4a and FIG. 4b, respectively. Specifically, FIG. 4a (on the left) illustrates an example of NR V2X and LTE V2X operating in TDM mode, while FIG. 4b (on the right) illustrates an example of NR V2X and LTE V2X operating in FDM mode.

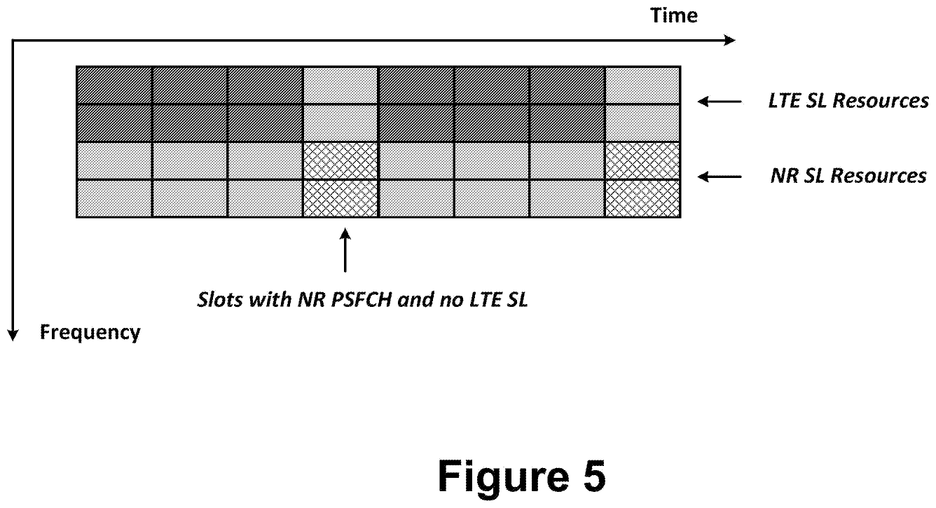

In one option of this embodiment, LTE SL is configured so that it doesn't use the slots that contain PSFCH transmissions from the NR system. One example of this option is illustrated in FIG. 5, which depicts the case when the PSFCH periodicity is set to 4. Specifically, FIG. 5 depicts an example of a semi-static FDM case with enabled HARQ feedback for the NR system.

### Dynamic Resource Pool Partitioning

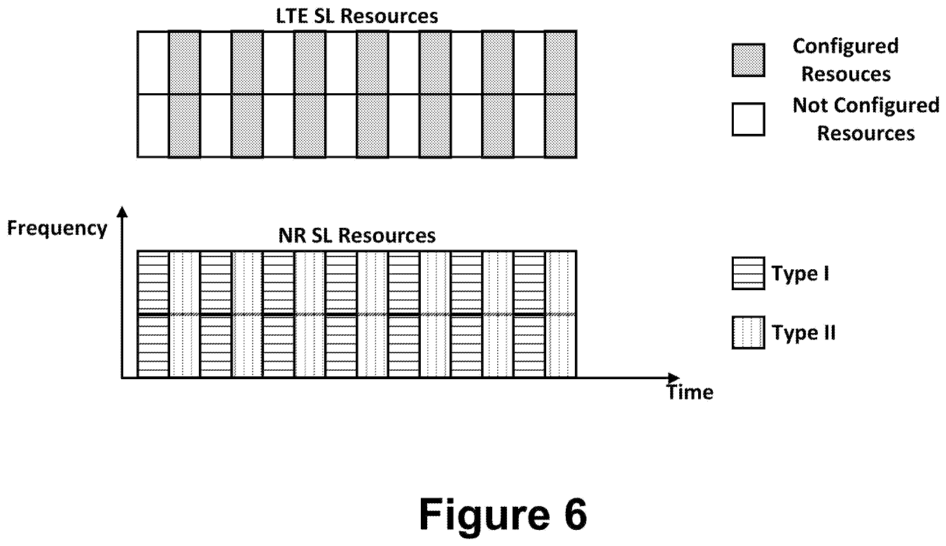

In one embodiment, resources within an NR SL resource pool may be divided into two types: type I where resources are used such that LTE and NR V2X may be operated in an orthogonal manner via higher layer signaling (e.g., RRC configuration), pre-configuration, or both, and type II, where resources may not be necessarily allocated in an orthogonal manner between LTE and NR V2X and may be allocated in a more dynamic manner following one or more of the mechanisms described along this disclosure. An example illustration of type I and type II resources is provided in FIG. 6.

In one embodiment, a UE may include both a NR SL and a LTE SL module, and the LTE SL module shares one or more of the following example parameters (and/or some other parameter(s)) with the NR SL module:
Time and frequency locations of reserved LTE transmissions
Resource reservation periods
SL RSRP and/or SL RSSI measurement reports
Half-duplex subframes which are not monitored by the LTE SL UE.

In another embodiment, the type I and type II resources are split into separate resource pools for mode 2 for the NR SL system. UEs without the capability to receive LTE SL transmission are transmitted only in type I resource pool, but could decode all NR SL transmission in the type II resources. UEs being able to receive LTE SL transmissions are allowed to transmit in both type I and II resource pools.

In one embodiment, one or more of the following example mechanisms may be adopted for UEs in SL resource allocation mode 2 (it will be noted that the following are examples of such mechanisms, and other embodiments may include additional/alternative mechanisms):
Resource selection based on NR+LTE sensing and reserved resources: for type II resources or aggregation of type I and type II resources, a UE may perform the selection of the candidate resources to use through the legacy sensing and resource selection procedure defined in TS 38.124 Sec. 8.1.4, where the exclusion rules defined in step 6 of this procedure may now include the reserved resources from LTE devices, and additionally the LTE sensing: such information may be either retrieved by a UE via inter-UE coordination/signalling via other UEs capable to decode the LTE SCIs, or by decoding itself the LTE sidelink control information(s) (SCI(s)) via proper implementation (e.g., via implementing a dual module or single module with NR-SL and LTE-SL capabilities). In this matter, a UE may exclude any candidate single-slot resource if it meets all the following example conditions (and/or one or more additional/alternative conditions):
UE receives an NR SCI (i.e., format 1-A) and/or an LTE SCI which reserves SL resources overlapping with a candidate resource;
   In one option, any LTE reserved SL resources overlapping with a candidate resource are considered;
   In one option, only LTE reserved SL resources overlapping with a candidate resource which are associated with a higher or same priority as the candidate resource are considered.
Reference signal received power (RSRP) measurement (i.e., NR+LTE) is higher than the configured threshold defined based on the Rx NR priority (i.e., carried in NR SCI format 1-A) or Rx LTE priority (i.e., carried in LTE SCI format 1) or the highest (or lowest) or more stringent (or more relaxed) between the two. In addition, the priority of the resources reserved for the LTE system can be interpreted as having the highest priority despite of the priority set in the related LTE SCI information.
NR and LTE reserved resources overlap with a considered candidate resource including potential future overlaps outside of the resource selection window that may happen due to different periodicities.

In one embodiment, the aforementioned modified exclusion rules may be only used by a UE based on capability signaling. In another embodiment, the aforementioned modified exclusion rules may be enabled or disabled based on higher layer signaling (e.g., RRC signaling) and/or pre-configuration.

In one embodiment, in the aforementioned modified exclusion rules a UE may additionally consider for excluding any resources overlapping with subframes which cannot be monitored by the LTE SL UE due to half-duplexing reasons, during which the SL UE in LTE mode is either transmitting or receiving or simply not performing any sensing. In one option, resources overlapping with subframes that cannot be monitored by the LTE SL UE due to half-duplexing reasons, are included in the reserved SL resources used for resources exclusion.

Notice that the embodiments listed herein may not be mutually exclusive, and one or more of them may apply together.
Resource exclusion of LTE reserved resources: for type II resources or aggregation of type I and type II resources, the set of slots allocated for LTE SL resources may be excluded for the determination of the set of slots for NR SL communication resource pool. In particular, the following procedure can be used to determine the set of slots for NR SL communication resource pool, where the set of slots includes all the slots except the following example slots (and/or some other type of slot):
   Slots where a SL synchronization signal block (S-SSB) resource are configured;
   Slots which are identified as non-SL slots, where some orthogonal frequency division multiplexed (OFDM) symbols are not semi-statically configured as uplink UL in this slot as determined in Section 8 of the 3GPP technical specification (TS) 38.214.
   Slots that are allocated for LTE SL resources, where such information may be either retrieved by a UE via inter-UE coordination/signalling via other UEs capable to decode the LTE SCIs, or by decoding itself the LTE SCIs via proper implementation (e.g., via implementing a dual module or single module with NR-SL and LTE-SL capabilities).
   Reserved slots as determined in Section 8 in 3GPP TS 38.214.

In one embodiment, the aforementioned modified exclusion rule may be only used by a UE based on capability signaling. In another embodiment, the aforementioned modified exclusion rules may be enabled or disabled based on RRC signaling or pre-configuration. In one embodiment, the set of slots which may need to be excluded from the set of slots for an NR SL communication resource pool may additionally include slots overlapping with any subframes which cannot be monitored by the LTE module due to half-duplexing reasons, and which may be retrieved by a UE via proper implementation (e.g., via implementing a dual module or single module with NR-SL and LTE-SL capabilities).
Resource exclusion of LTE reserved resources based on priority: for type II resources or aggregation of type I and type II resources, a UE may perform the selection of the candidate resources to use through the legacy sensing and resource selection procedure defined in 3GPP TS 38.124 Sec. 8.1.4, where in addition a UE may exclude a priori any slots that may have been reserved by LTE UEs, where such information may be either retrieved by a UE via inter-UE coordination/signalling via other UEs capable to decode the LTE SCIs, or by decoding itself the LTE SCIs via proper implementation (e.g., via implementing a dual module or single module with NR-SL and LTE-SL capabilities). In one option, when excluding the reserved resources by LTE, a UE may consider all of them, while in another option a UE may only consider the LTE reserved SL resources which are associated with an higher or same priority as the candidate resource.

In one embodiment, the aforementioned modified exclusion rule may be only used by a UE based on capability signaling. In another embodiment, the aforementioned modified exclusion rules may be enabled or disabled based on RRC signaling or pre-configuration.

Notice that the embodiment listed here are not mutually exclusive, and one or more of them may apply together.
Resource selection based on LTE reserved resources: for type II resources or aggregation of type I and type II resources, (where type I and type II resources are as defined in prior embodiment), a UE may perform the selection of the candidate resources to use by firstly identifying a set of candidate resources by following the legacy sensing and resource selection procedure defined in 3GPP TS 38.124 Sec. 8.1.4, and then by applying one or more of the following additional exclusion rules:
   If a UE determines that an LTE SL UE may have reserved the same single-slot resource or overlapping single-slot resources over which it may perform a transmission, that transmission may be dropped;
   If a UE determines that an LTE SL UE may have reserved a single-slot resource or single-slot resources overlapping with some of the candidate resources defined during the NR SL sensing and resource selection procedure, those resources will be excluded from the candidate resources.

A UE may retrieve the reserved resources from LTE devices via inter-UE coordination/signalling via other UEs capable to decode the LTE SCIs, or by decoding itself the LTE SCIs via proper implementation (e.g., via implementing a dual module or single module with NR-SL and LTE-SL capabilities). Furthermore, in one option, when dropping a transmission or excluding a candidate resource based on the reserved resources by LTE, a UE may consider all of the reserved resources by LTE, while in another option a UE may only consider the LTE reserved SL resources which are associated with an higher or same priority as the candidate resource or the resource over which a transmission may be meant.

In one embodiment, the aforementioned rules may be only used by a UE based on capability signaling. In another embodiment, the aforementioned modified exclusion rules may be enabled or disabled based on RRC signaling or pre-configuration. In one embodiment, in addition to the exclusion rules listed above, a UE may additionally drop or cancel any transmission that may overlap with any resources overlapping with any subframes which cannot be monitored by the LTE module due to half-duplexing reasons, and which may be retrieved by a UE via proper implementation (e.g., via implementing a dual module or single module with NR-SL and LTE-SL capabilities).

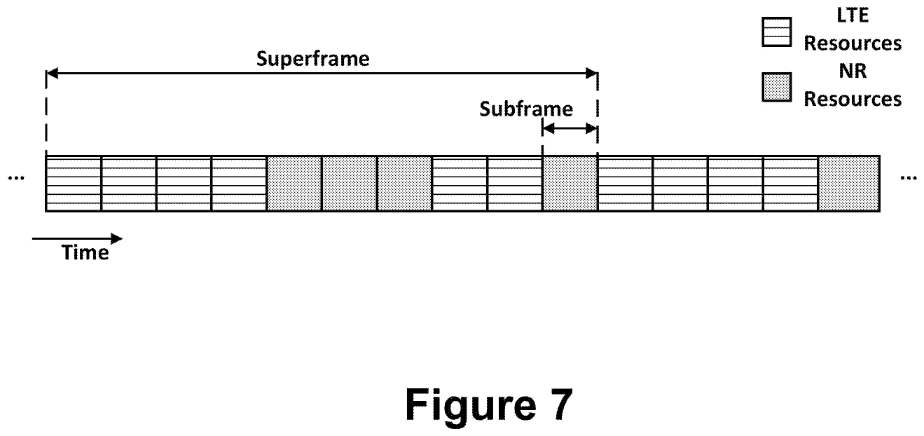

Notice that the embodiment listed here are not mutually exclusive, and one or more of them may apply together.
TDD between LTE and NR over a super-frame: a super-frame may be composed by a radio-frame or N subframes, where N may be fixed or configurable. Within a super-frame, the type II or both type I and type II subframes may be associated to either LTE or NR via a specific configuration which is known by both technologies, and may be semi-statically configured. The specific TDD configuration to use may be RRC configured or pre-configured. FIG. 7 depicts an example illustration of TDD between LTE resources and NR SL resources.
Detect and avoid (DAA) mechanism: for type II resources or aggregation of type I and type II resources, a UE may perform a detection and avoid procedure by performing a short term sensing right before the single-slot resource selected for transmission. In this case, if the RSRP measurement performed right before a potential transmission is higher than a configured or pre-configured threshold, a UE may drop its transmission, and select another resource from the candidate resources to perform a transmission, otherwise the device may transmit immediately. In one option, the sensing procedure may be equivalent to Cat-2A LBT or Cat-1 LBT with the lowest priority class or a single 9 us clear channel assessment. In one option, a SL slot may never start in symbol #0 if NR supports 15 KHz SCS.

In one embodiment, the aforementioned procedure may be only used by a UE based on capability signaling. In another embodiment, the aforementioned procedure may be enabled or disabled based on RRC signaling or pre-configuration.

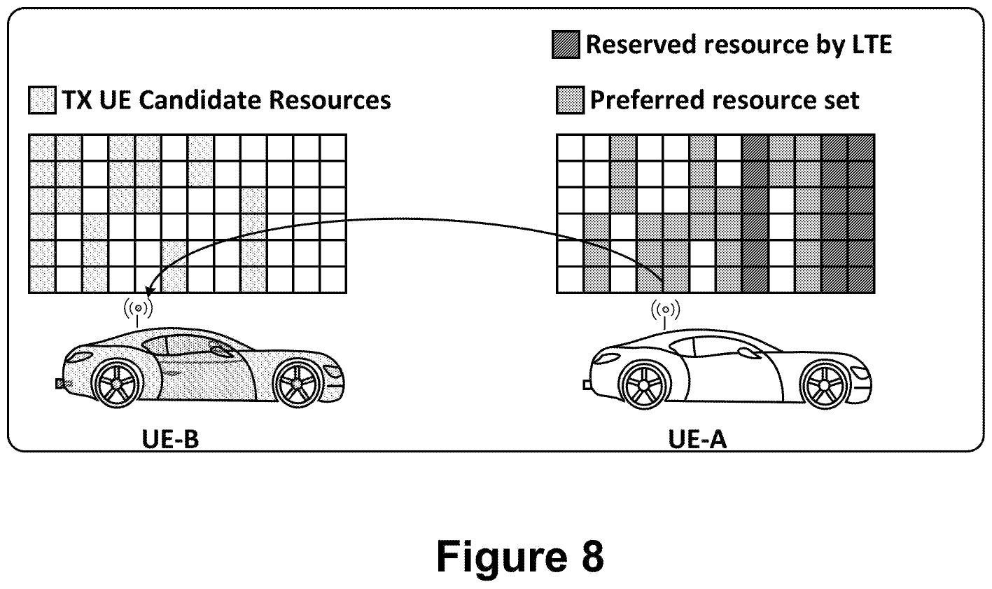

Notice that the embodiment listed here are not mutually exclusive, and one or more of them may apply together.
Inter-UE coordination with exchange of information related to LTE reserved resources: for type II resources or aggregation of type I and type II resources, one of the following mechanisms may be adopted:
   Inter-UE Coordination Scheme 1 may be enhanced so that to include within the inter-UE coordination (IUC) feedback informant sent from UE-A to UE-B not only the set of preferred resources by UE-A, but also the resource reserved by LTE which are sensed by UE-A. In this case, the candidate resources selected by UE-B will exclude all preferred resources indicated by UE-A including those reserved by LTE and sensed by UE-A. FIG. 8 depicts an example illustration of an enhanced inter-UE coordination scheme (scheme 1).

In one embodiment, the aforementioned procedure may be only used by a UE based on capability signaling. In another embodiment, the aforementioned procedure may be enabled or disabled based on RRC signaling or pre-configuration.

In one embodiment, the preferred resources by UE-A may additionally include any resource overlapping with any subframes which cannot be monitored by the LTE module due to half-duplexing reasons, and which may be retrieved by a UE via proper implementation (e.g., via implementing a dual module or single module with NR-SL and LTE-SL capabilities).

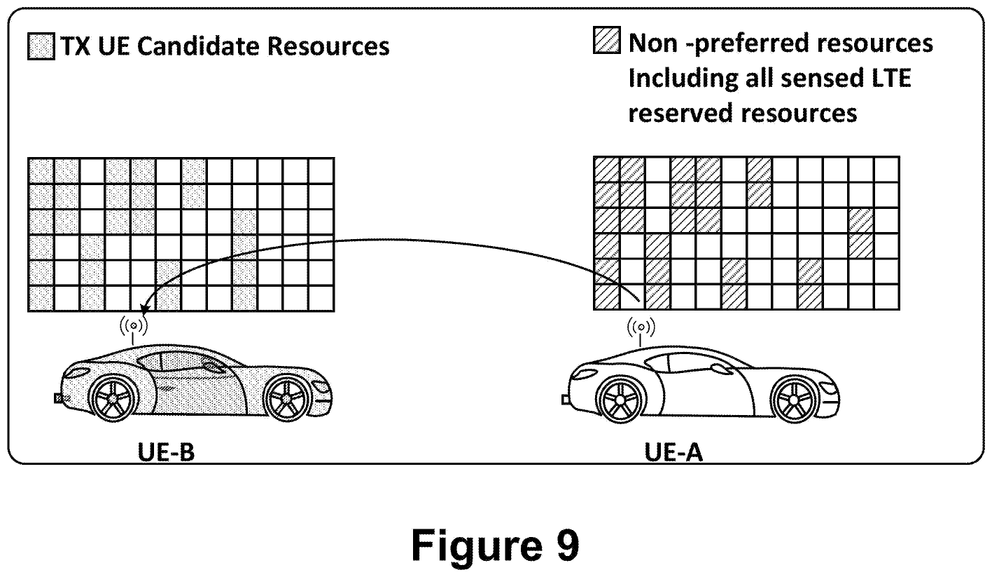

Notice that the embodiment listed here are not mutually exclusive, and one or more of them may apply together. Also notice that a UE-A may retrieve the reserved resources from LTE devices by decoding itself the LTE SCIs via proper implementation (e.g., via implementing a dual module or single module with NR-SL and LTE-SL capabilities).
Inter-UE Coordination Scheme 1 may be enhanced so that to include within the inter-UE coordination (IUC) feedback informant sent from UE-A to UE-B the set of non-preferred resources by UE-A which may need to also exclude any resource reserved by LTE which are sensed by UE-A. In this case, the candidate resources selected by UE-B may include all non-preferred resources, which exclude those reserved by LTE and sensed by UE-A. FIG. 9 depicts an example of an enhancement to the inter-UE coordination scheme 1.

In one embodiment, the aforementioned procedure may be only used by a UE based on capability signaling. In another embodiment, the aforementioned procedure may be enabled or disabled based on RRC signaling or pre-configuration.

In one embodiment, the non-preferred resource by UE-A may additionally exclude any resource overlapping with any subframes which cannot be monitored by the LTE module due to half-duplexing reasons, and which may be retrieved by a UE via proper implementation (e.g., via implementing a dual module or single module with NR-SL and LTE-SL capabilities).

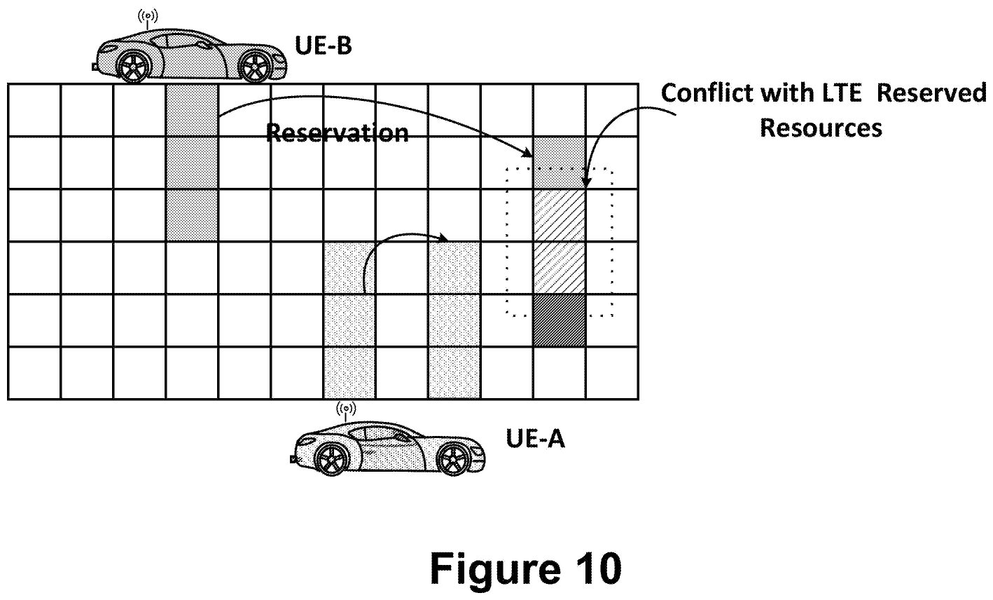

Notice that the embodiment listed here are not mutually exclusive, and one or more of them may apply together. Also notice that a UE-A may retrieve the reserved resources from LTE devices by decoding itself the LTE SCIs via proper implementation (e.g., via implementing a dual module or single module with NR-SL and LTE-SL capabilities).
Inter-UE Coordination Scheme 2 may be enhanced so that UE-A may generate IUC feedback information indicating potential conflict to UE-B reserving resources if not only it may detect expected/potential SL conflict on UE-B's reserved resources, but also by accounting for any potential conflict with the resources reserved by LTE which are sensed by UE-A and/or any resources overlapping with any subframes which cannot be monitored by the LTE module of UE-A due to half-duplexing reasons, and which may be retrieved by UE-A via proper implementation (e.g., via implementing a dual module or single module with NR-SL and LTE-SL capabilities). FIG. 10 depicts an example illustration of an enhanced inter-UE coordination scheme (e.g., scheme 2).

In one embodiment, the aforementioned procedure may be only used by a UE based on capability signaling. In another embodiment, the aforementioned procedure may be enabled or disabled based on RRC signaling or pre-configuration.

Notice that the embodiment listed here are not mutually exclusive, and one or more of them may apply together. Also notice that a UE-A may retrieve the reserved resources from LTE devices by decoding itself the LTE SCIs via proper implementation (e.g., via implementing a dual module or single module with NR-SL and LTE-SL capabilities).

In one embodiment, regardless of whether a semi-static or dynamic resource partitioning is adopted, when LTE V2X and NR V2X may need to co-exist, NR V2X may only support 15 KHz SCS. In another embodiment, regardless of whether a semi-static or dynamic resource partitioning is adopted, when LTE V2X and NR V2X may need to co-exist, PSFCH should never be configured.

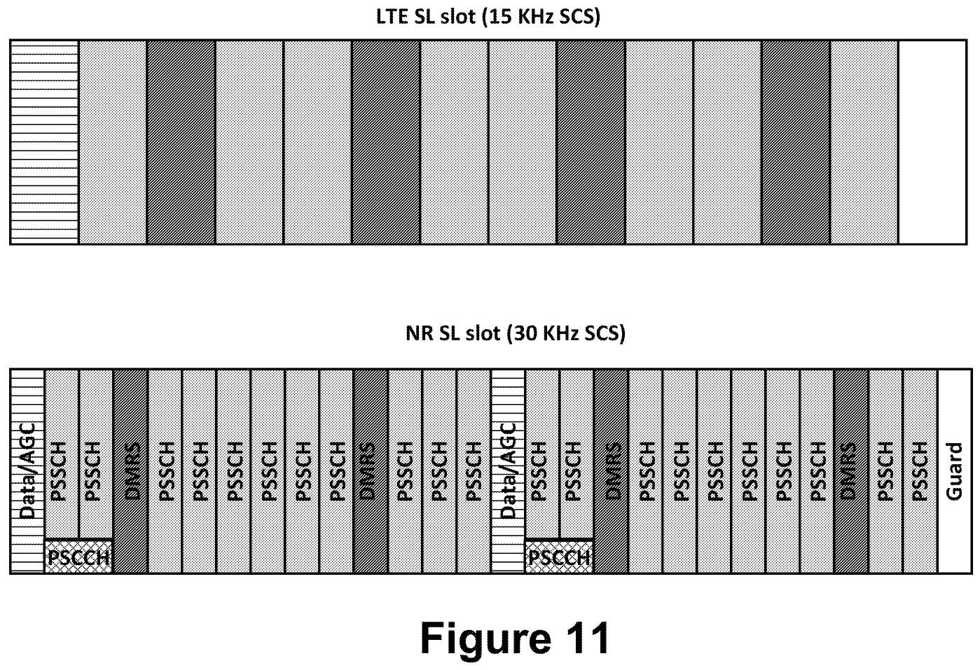

In one embodiment, when LTE V2X and NR V2X may need to co-exist, NR V2X may support both 15 KHz and 30 KHz SCS. In this case one or more of the following options could be adopted:
Exclusion of all slots overlapping with busy or potentially busy subframes: When the NR V2X system operated at 30 KHz SCS or 60 KHz, an NR SL UE in mode 2 may exclude a priori from the set of suitable resources for SL transmission all the slots overlapping with the subframes belonging to the resource reserved for LTE transmissions, where such information may be either retrieved by a UE via inter-UE coordination/signalling via other UEs capable to decode the LTE SCIs, or by decoding itself the LTE SCIs via proper implementation (e.g., via implementing a dual module or single module with NR-SL and LTE-SL capabilities). In addition, an NR SL UE in mode 2 may also exclude a priori any subframe which cannot be monitored by the LTE module due to half-duplexing reasons, and which may be retrieved by a UE via proper implementation (e.g., via implementing a dual module or single module with NR-SL and LTE-SL capabilities).
Exclusion of all slots with exception of the first slots overlapping with busy or potentially busy subframes: When the NR V2X system operated at 30 KHz or 60 KHz SCS, an NR SL UE in mode 2 may exclude a priori from the set of suitable resources for SL transmission all the slots overlapping with the subframes belonging to the resource reserved for LTE transmissions except for the first slots of such subframes. Such information may be either retrieved by a UE via inter-UE coordination/signalling via other UEs capable to decode the LTE SCIs, or by decoding itself the LTE SCIs via proper implementation (e.g., via implementing a dual module or single module with NR-SL and LTE-SL capabilities). In addition, an NR SL UE in mode 2 may also exclude a priori all the slots overlapping with the subframe which cannot be monitored by the LTE module due to half-duplexing reasons except for the first slots of such subframes. The subframe which cannot be monitored by the LTE module due to half-duplexing reasons may be retrieved by a UE via proper implementation (e.g., via implementing a dual module or single module with NR-SL and LTE-SL capabilities).
Multi-consecutive slot transmission: When the NR V2X uses 30 or 60 kHz SCS, multi slot transmissions without gaps are used for a SL transmission, meaning that a SL transmission may span contiguously over a number of slots equivalent to the duration of a 15 KHz SCS slot (i.e., 2 for 30 KHz and 4 for 60 KHz). Note that these will occupy the same time as the corresponding LTE V2X sub-frame. For 30 kHz SCS this means it is only possible to transmit n*2 slots combined to avoid AGC problems of the LTE system. For 60 kHz this means n*4 slots need to be combined for one multi-slot transmission. In both cases, n is a natural number (non-negative integer) larger than zero. Note this solution is applicable for the dynamic coexistence as well as the FDM based coexistence. An example of a multi-slot transmission for coexistence when the NR system operates at 30 KHz SCS is shown in FIG. 11. For example, FIG. 11 depicts an example illustration of a multi-slot solution to avoid AGC problems of the LTE V2X system. In one option, in order to realize the aforementioned solution, the first symbol of each additional SL slot transmission may either be an AGC symbol (as shown in FIG. 11) or a symbol used for PSCCH/PSSCH transmission. Note that in one option the control information may be only transmitted in the first slot of the combined multi-slot transmission.

In one embodiment, when LTE V2X and NR V2X may need to co-exist, and NR V2X may configured PSFCH, one or more of the following options could be adopted:
In one option, resource are distinguished in type I and type II resources as defined in prior embodiment, and a PSFCH resource may always fall within type I resources. In other words, LTE (pre-)configured resources will not overlap with NR resources where PSFCH is configured.
In one option, a NR SL UE in mode 2 may drop a PSFCH transmission if this overlaps with any reserved resources for LTE transmissions, where such information may be either retrieved by a UE via inter-UE coordination/signalling via other UEs capable to decode the LTE SCIs, or by decoding itself the LTE SCIs via proper implementation (e.g., via implementing a dual module or single module with NR-SL and LTE-SL capabilities). In addition, a UE may also drop a PSFCH transmission if this overlaps with any resources belonging to a subframe which cannot be monitored by the LTE module due to half-duplexing reasons except for the first slots of such subframes, where such information may be retrieved by a UE via proper implementation (e.g., via implementing a dual module or single module with NR-SL and LTE-SL capabilities).
In one option, a NR SL UE in mode 2 may drop a PSSCH/PSCCH transmission if the corresponding PSFCH may overlaps with any reserved resources for LTE transmissions, where such information may be either retrieved by a UE via inter-UE coordination/signaling via other UEs capable to decode the LTE SCIs, or by decoding itself the LTE SCIs via proper implementation (e.g., via implementing a dual module or single module with NR-SL and LTE-SL capabilities). In addition, a UE may also drop a PSSCH/PSCCH transmission if the corresponding PSFCH may overlaps with any resources belonging to a subframe which cannot be monitored by the LTE module due to half-duplexing reasons except for the first slots of such subframes, where such information may be retrieved by a UE via proper implementation (e.g., via implementing a dual module or single module with NR-SL and LTE-SL capabilities).

In another embodiment, to prevent unintentional interference during the time the synchronization source of either LTE or NR V2X is changed the system is not transmitting if such a situation is detected or can be predicted in the imminent future. Note that it is also possible that a device that possessed the capability to communicate using both standards is detecting or predicating this change on only one of these systems and is afterwards dropping transmissions for both. The detection of the synchronization change can be based on a subset of the following information:
Entering or leaving network coverage
Entering or leaving GNSS coverage
Entering or leaving SL S-SSB coverage
Rapidly decreasing reception quality for one of the synchronization sources
Rapidly decreasing channel quality
Increasing errors for transmission or reception of transmissions
Rapidly changing congestion control status
Side information outside of communication systems like camera, location information of stored past context information
Predicted changes of the synchronization source based on a combination of context information synthesize by AI/ML

### Systems and Implementations

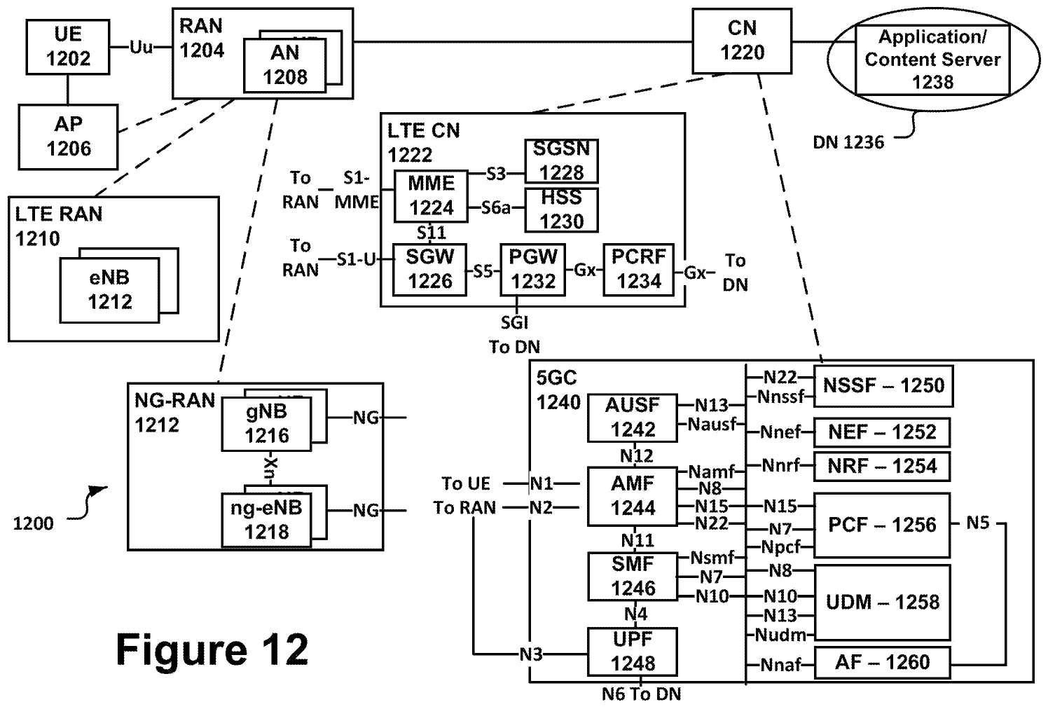

FIGS. 12-15 illustrate various systems, devices, and components that may implement aspects of disclosed embodiments.

FIG. 12 illustrates a network 1200 in accordance with various embodiments. The network 1200 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 1200 may include a UE 1202, which may include any mobile or non-mobile computing device designed to communicate with a RAN 1204 via an over-the-air connection. The UE 1202 may be communicatively coupled with the RAN 1204 by a Uu interface. The UE 1202 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 1200 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 1202 may additionally communicate with an AP 1206 via an over-the-air connection. The AP 1206 may manage a WLAN connection, which may serve to offload some/all network traffic from the RAN 1204. The connection between the UE 1202 and the AP 1206 may be consistent with any IEEE 802.11 protocol, wherein the AP 1206 could be a wireless fidelity (Wi-Fi®) router. In some embodiments, the UE 1202, RAN 1204, and AP 1206 may utilize cellular-WLAN aggregation (for example, LWA/LWIP). Cellular-WLAN aggregation may involve the UE 1202 being configured by the RAN 1204 to utilize both cellular radio resources and WLAN resources.

The RAN 1204 may include one or more access nodes, for example, AN 1208. AN 1208 may terminate air-interface protocols for the UE 1202 by providing access stratum protocols including RRC, PDCP, RLC, MAC, and L1 protocols. In this manner, the AN 1208 may enable data/voice connectivity between CN 1220 and the UE 1202. In some embodiments, the AN 1208 may be implemented in a discrete device or as one or more software entities running on server computers as part of, for example, a virtual network, which may be referred to as a CRAN or virtual baseband unit pool. The AN 1208 be referred to as a BS, gNB, RAN node, eNB, ng-eNB, NodeB, RSU, TRxP, TRP, etc. The AN 1208 may be a macrocell base station or a low power base station for providing femtocells, picocells or other like cells having smaller coverage areas, smaller user capacity, or higher bandwidth compared to macrocells.

In embodiments in which the RAN 1204 includes a plurality of ANs, they may be coupled with one another via an X2 interface (if the RAN 1204 is an LTE RAN) or an Xn interface (if the RAN 1204 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 1204 may each manage one or more cells, cell groups, component carriers, etc. to provide the UE 1202 with an air interface for network access. The UE 1202 may be simultaneously connected with a plurality of cells provided by the same or different ANs of the RAN 1204. For example, the UE 1202 and RAN 1204 may use carrier aggregation to allow the UE 1202 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 1204 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 1202 or AN 1208 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 1204 may be an LTE RAN 1210 with eNBs, for example, eNB 1212. The LTE RAN 1210 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 1204 may be an NG-RAN 1214 with gNBs, for example, gNB 1216, or ng-eNBs, for example, ng-eNB 1218. The gNB 1216 may connect with 5G-enabled UEs using a 5G NR interface. The gNB 1216 may connect with a 5G core through an NG interface, which may include an N2 interface or an N3 interface. The ng-eNB 1218 may also connect with the 5G core through an NG interface, but may connect with a UE via an LTE air interface. The gNB 1216 and the ng-eNB 1218 may connect with each other over an Xn interface.

In some embodiments, the NG interface may be split into two parts, an NG user plane (NG-U) interface, which carries traffic data between the nodes of the NG-RAN 1214 and a UPF 1248 (e.g., N3 interface), and an NG control plane (NG-C) interface, which is a signaling interface between the nodes of the NG-RAN 1214 and an AMF 1244 (e.g., N2 interface).

The NG-RAN 1214 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 1202 can be configured with multiple BWPs where each BWP configuration has a different SCS. When a BWP change is indicated to the UE 1202, the SCS of the transmission is changed as well. Another use case example of BWP is related to power saving. In particular, multiple BWPs can be configured for the UE 1202 with different amount of frequency resources (for example, PRBs) to support data transmission under different traffic loading scenarios. A BWP containing a smaller number of PRBs can be used for data transmission with small traffic load while allowing power saving at the UE 1202 and in some cases at the gNB 1216. A BWP containing a larger number of PRBs can be used for scenarios with higher traffic load.

The RAN 1204 is communicatively coupled to CN 1220 that includes network elements to provide various functions to support data and telecommunications services to customers/subscribers (for example, users of UE 1202). The components of the CN 1220 may be implemented in one physical node or separate physical nodes. In some embodiments, NFV may be utilized to virtualize any or all of the functions provided by the network elements of the CN 1220 onto physical compute/storage resources in servers, switches, etc. A logical instantiation of the CN 1220 may be referred to as a network slice, and a logical instantiation of a portion of the CN 1220 may be referred to as a network sub-slice.

In some embodiments, the CN 1220 may be an LTE CN 1222, which may also be referred to as an EPC. The LTE CN 1222 may include MME 1224, SGW 1226, SGSN 1228, HSS 1230, PGW 1232, and PCRF 1234 coupled with one another over interfaces (or “reference points”) as shown. Functions of the elements of the LTE CN 1222 may be briefly introduced as follows.

The MME 1224 may implement mobility management functions to track a current location of the UE 1202 to facilitate paging, bearer activation/deactivation, handovers, gateway selection, authentication, etc.

The SGW 1226 may terminate an S1 interface toward the RAN and route data packets between the RAN and the LTE CN 1222. The SGW 1226 may be a local mobility anchor point for inter-RAN node handovers and also may provide an anchor for inter-3GPP mobility. Other responsibilities may include lawful intercept, charging, and some policy enforcement.

The SGSN 1228 may track a location of the UE 1202 and perform security functions and access control. In addition, the SGSN 1228 may perform inter-EPC node signaling for mobility between different RAT networks; PDN and S-GW selection as specified by MME 1224; MME selection for handovers; etc. The S3 reference point between the MME 1224 and the SGSN 1228 may enable user and bearer information exchange for inter-3GPP access network mobility in idle/active states.

The HSS 1230 may include a database for network users, including subscription-related information to support the network entities' handling of communication sessions. The HSS 1230 can provide support for routing/roaming, authentication, authorization, naming/addressing resolution, location dependencies, etc. An S6a reference point between the HSS 1230 and the MME 1224 may enable transfer of subscription and authentication data for authenticating/authorizing user access to the LTE CN 1220.

The PGW 1232 may terminate an SGi interface toward a data network (DN) 1236 that may include an application/content server 1238. The PGW 1232 may route data packets between the LTE CN 1222 and the data network 1236. The PGW 1232 may be coupled with the SGW 1226 by an S5 reference point to facilitate user plane tunneling and tunnel management. The PGW 1232 may further include a node for policy enforcement and charging data collection (for example, PCEF). Additionally, the SGi reference point between the PGW 1232 and the data network 12 36 may be an operator external public, a private PDN, or an intra-operator packet data network, for example, for provision of IMS services. The PGW 1232 may be coupled with a PCRF 1234 via a Gx reference point.

The PCRF 1234 is the policy and charging control element of the LTE CN 1222. The PCRF 1234 may be communicatively coupled to the app/content server 1238 to determine appropriate QoS and charging parameters for service flows. The PCRF 1232 may provision associated rules into a PCEF (via Gx reference point) with appropriate TFT and QCI.

In some embodiments, the CN 1220 may be a 5GC 1240. The 5GC 1240 may include an AUSF 1242, AMF 1244, SMF 1246, UPF 1248, NSSF 1250, NEF 1252, NRF 1254, PCF 1256, UDM 1258, and AF 1260 coupled with one another over interfaces (or “reference points”) as shown. Functions of the elements of the 5GC 1240 may be briefly introduced as follows.

The AUSF 1242 may store data for authentication of UE 1202 and handle authentication-related functionality. The AUSF 1242 may facilitate a common authentication framework for various access types. In addition to communicating with other elements of the 5GC 1240 over reference points as shown, the AUSF 1242 may exhibit an Nausf service-based interface.

The AMF 1244 may allow other functions of the 5GC 1240 to communicate with the UE 1202 and the RAN 1204 and to subscribe to notifications about mobility events with respect to the UE 1202. The AMF 1244 may be responsible for registration management (for example, for registering UE 1202), connection management, reachability management, mobility management, lawful interception of AMF-related events, and access authentication and authorization. The AMF 1244 may provide transport for SM messages between the UE 1202 and the SMF 1246, and act as a transparent proxy for routing SM messages. AMF 1244 may also provide transport for SMS messages between UE 1202 and an SMSF. AMF 1244 may interact with the AUSF 1242 and the UE 1202 to perform various security anchor and context management functions. Furthermore, AMF 1244 may be a termination point of a RAN CP interface, which may include or be an N2 reference point between the RAN 1204 and the AMF 1244; and the AMF 1244 may be a termination point of NAS (N1) signaling, and perform NAS ciphering and integrity protection. AMF 1244 may also support NAS signaling with the UE 1202 over an N3 IWF interface.

The SMF 1246 may be responsible for SM (for example, session establishment, tunnel management between UPF 1248 and AN 1208); UE IP address allocation and management (including optional authorization); selection and control of UP function; configuring traffic steering at UPF 1248 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 1244 over N2 to AN 1208; and determining SSC mode of a session. SM may refer to management of a PDU session, and a PDU session or “session” may refer to a PDU connectivity service that provides or enables the exchange of PDUs between the UE 1202 and the data network 1236.

The UPF 1248 may act as an anchor point for intra-RAT and inter-RAT mobility, an external PDU session point of interconnect to data network 1236, and a branching point to support multi-homed PDU session. The UPF 1248 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 1248 may include an uplink classifier to support routing traffic flows to a data network.

The NSSF 1250 may select a set of network slice instances serving the UE 1202. The NSSF 1250 may also determine allowed NSSAI and the mapping to the subscribed S-NSSAIs, if needed. The NSSF 1250 may also determine the AMF set to be used to serve the UE 1202, or a list of candidate AMFs based on a suitable configuration and possibly by querying the NRF 1254. The selection of a set of network slice instances for the UE 1202 may be triggered by the AMF 1244 with which the UE 1202 is registered by interacting with the NSSF 1250, which may lead to a change of AMF. The NSSF 1250 may interact with the AMF 1244 via an N22 reference point; and may communicate with another NSSF in a visited network via an N31 reference point (not shown). Additionally, the NSSF 1250 may exhibit an Nnssf service-based interface.

The NEF 1252 may securely expose services and capabilities provided by 3GPP network functions for third party, internal exposure/re-exposure, AFs (e.g., AF 1260), edge computing or fog computing systems, etc. In such embodiments, the NEF 1252 may authenticate, authorize, or throttle the AFs. NEF 1252 may also translate information exchanged with the AF 1260 and information exchanged with internal network functions. For example, the NEF 1252 may translate between an AF-Service-Identifier and an internal 5GC information. NEF 1252 may also receive information from other NFs based on exposed capabilities of other NFs. This information may be stored at the NEF 1252 as structured data, or at a data storage NF using standardized interfaces. The stored information can then be re-exposed by the NEF 1252 to other NFs and AFs, or used for other purposes such as analytics. Additionally, the NEF 1252 may exhibit an Nnef service-based interface.

The NRF 1254 may support service discovery functions, receive NF discovery requests from NF instances, and provide the information of the discovered NF instances to the NF instances. NRF 1254 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 1254 may exhibit the Nnrf service-based interface.

The PCF 1256 may provide policy rules to control plane functions to enforce them, and may also support unified policy framework to govern network behavior. The PCF 1256 may also implement a front end to access subscription information relevant for policy decisions in a UDR of the UDM 1258. In addition to communicating with functions over reference points as shown, the PCF 1256 exhibit an Npcf service-based interface.

The UDM 1258 may handle subscription-related information to support the network entities' handling of communication sessions, and may store subscription data of UE 1202. For example, subscription data may be communicated via an N8 reference point between the UDM 1258 and the AMF 1244. The UDM 1258 may include two parts, an application front end and a UDR. The UDR may store subscription data and policy data for the UDM 1258 and the PCF 1256, and/or structured data for exposure and application data (including PFDs for application detection, application request information for multiple UEs 1202) for the NEF 1252. The Nudr service-based interface may be exhibited by the UDR 221 to allow the UDM 1258, PCF 1256, and NEF 1252 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1258 may exhibit the Nudm service-based interface.

The AF 1260 may provide application influence on traffic routing, provide access to NEF, and interact with the policy framework for policy control.

In some embodiments, the 5GC 1240 may enable edge computing by selecting operator/3^{rd} party services to be geographically close to a point that the UE 1202 is attached to the network. This may reduce latency and load on the network. To provide edge-computing implementations, the 5GC 1240 may select a UPF 1248 close to the UE 1202 and execute traffic steering from the UPF 1248 to data network 1236 via the N6 interface. This may be based on the UE subscription data, UE location, and information provided by the AF 1260. In this way, the AF 1260 may influence UPF (re)selection and traffic routing. Based on operator deployment, when AF 1260 is considered to be a trusted entity, the network operator may permit AF 1260 to interact directly with relevant NFs. Additionally, the AF 1260 may exhibit an Naf service-based interface.

The data network 1236 may represent various network operator services, Internet access, or third party services that may be provided by one or more servers including, for example, application/content server 1238.

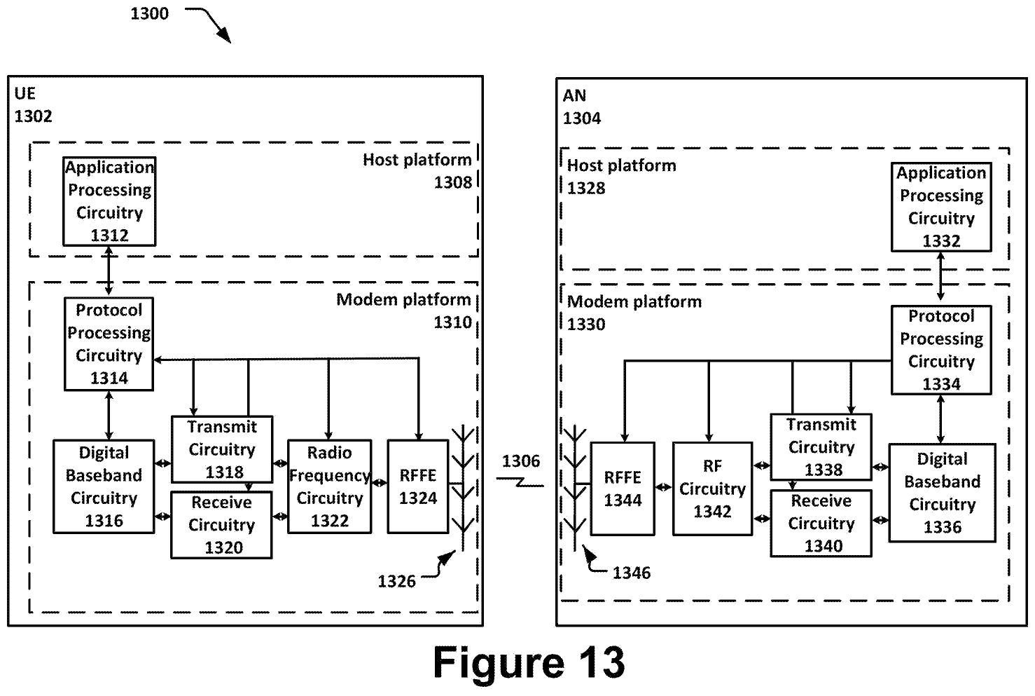

FIG. 13 schematically illustrates a wireless network 1300 in accordance with various embodiments. The wireless network 1300 may include a UE 1302 in wireless communication with an AN 1304. The UE 1302 and AN 1304 may be similar to, and substantially interchangeable with, like-named components described elsewhere herein.

The UE 1302 may be communicatively coupled with the AN 1304 via connection 1306. The connection 1306 is illustrated as an air interface to enable communicative coupling, and can be consistent with cellular communications protocols such as an LTE protocol or a 5G NR protocol operating at mmWave or sub-6 GHz frequencies.

The UE 1302 may include a host platform 1308 coupled with a modem platform 1310. The host platform 1308 may include application processing circuitry 1312, which may be coupled with protocol processing circuitry 1314 of the modem platform 1310. The application processing circuitry 1312 may run various applications for the UE 1302 that source/sink application data. The application processing circuitry 1312 may further implement one or more layer operations to transmit/receive application data to/from a data network. These layer operations may include transport (for example UDP) and Internet (for example, IP) operations

The protocol processing circuitry 1314 may implement one or more of layer operations to facilitate transmission or reception of data over the connection 1306. The layer operations implemented by the protocol processing circuitry 1314 may include, for example, MAC, RLC, PDCP, RRC and NAS operations.

The modem platform 1310 may further include digital baseband circuitry 1316 that may implement one or more layer operations that are “below” layer operations performed by the protocol processing circuitry 1314 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1310 may further include transmit circuitry 1318, receive circuitry 1320, RF circuitry 1322, and RF front end (RFFE) 1324, which may include or connect to one or more antenna panels 1326. Briefly, the transmit circuitry 1318 may include a digital-to-analog converter, mixer, intermediate frequency (IF) components, etc.; the receive circuitry 1320 may include an analog-to-digital converter, mixer, IF components, etc.; the RF circuitry 1322 may include a low-noise amplifier, a power amplifier, power tracking components, etc.; RFFE 1324 may include filters (for example, surface/bulk acoustic wave filters), switches, antenna tuners, beamforming components (for example, phase-array antenna components), etc. The selection and arrangement of the components of the transmit circuitry 1318, receive circuitry 1320, RF circuitry 1322, RFFE 1324, and antenna panels 1326 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1314 may include one or more instances of control circuitry (not shown) to provide control functions for the transmit/receive components.

A UE reception may be established by and via the antenna panels 1326, RFFE 1324, RF circuitry 1322, receive circuitry 1320, digital baseband circuitry 1316, and protocol processing circuitry 1314. In some embodiments, the antenna panels 1326 may receive a transmission from the AN 1304 by receive-beamforming signals received by a plurality of antennas/antenna elements of the one or more antenna panels 1326.

A UE transmission may be established by and via the protocol processing circuitry 1314, digital baseband circuitry 1316, transmit circuitry 1318, RF circuitry 1322, RFFE 1324, and antenna panels 1326. In some embodiments, the transmit components of the UE 1304 may apply a spatial filter to the data to be transmitted to form a transmit beam emitted by the antenna elements of the antenna panels 1326.

Similar to the UE 1302, the AN 1304 may include a host platform 1328 coupled with a modem platform 1330. The host platform 1328 may include application processing circuitry 1332 coupled with protocol processing circuitry 1334 of the modem platform 1330. The modem platform may further include digital baseband circuitry 1336, transmit circuitry 1338, receive circuitry 1340, RF circuitry 1342, RFFE circuitry 1344, and antenna panels 1346. The components of the AN 1304 may be similar to and substantially interchangeable with like-named components of the UE 1302. In addition to performing data transmission/reception as described above, the components of the AN 1308 may perform various logical functions that include, for example, RNC functions such as radio bearer management, uplink and downlink dynamic radio resource management, and data packet scheduling.

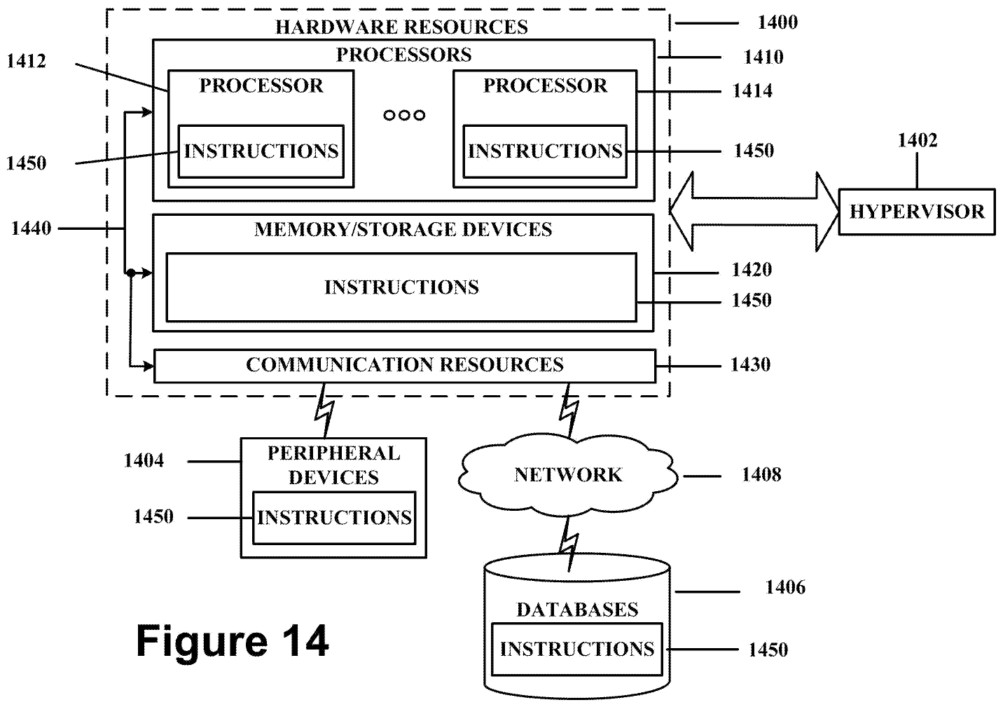

FIG. 14 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 14 shows a diagrammatic representation of hardware resources 1400 including one or more processors (or processor cores) 1410, one or more memory/storage devices 1420, and one or more communication resources 1430, each of which may be communicatively coupled via a bus 1440 or other interface circuitry. For embodiments where node virtualization (e.g., NFV) is utilized, a hypervisor 1402 may be executed to provide an execution environment for one or more network slices/sub-slices to utilize the hardware resources 1400.

The processors 1410 may include, for example, a processor 1412 and a processor 1414. The processors 1410 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), another processor (including those discussed herein), or any suitable combination thereof.

The memory/storage devices 1420 may include main memory, disk storage, or any suitable combination thereof. The memory/storage devices 1420 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1430 may include interconnection or network interface controllers, components, or other suitable devices to communicate with one or more peripheral devices 1404 or one or more databases 1406 or other network elements via a network 1408. For example, the communication resources 1430 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1450 may comprise software, a program, an application, an applet, an app, or other executable code for causing at least any of the processors 1410 to perform any one or more of the methodologies discussed herein. The instructions 1450 may reside, completely or partially, within at least one of the processors 1410 (e.g., within the processor's cache memory), the memory/storage devices 1420, or any suitable combination thereof. Furthermore, any portion of the instructions 1450 may be transferred to the hardware resources 1400 from any combination of the peripheral devices 1404 or the databases 1406. Accordingly, the memory of processors 1410, the memory/storage devices 1420, the peripheral devices 1404, and the databases 1406 are examples of computer-readable and machine-readable media.

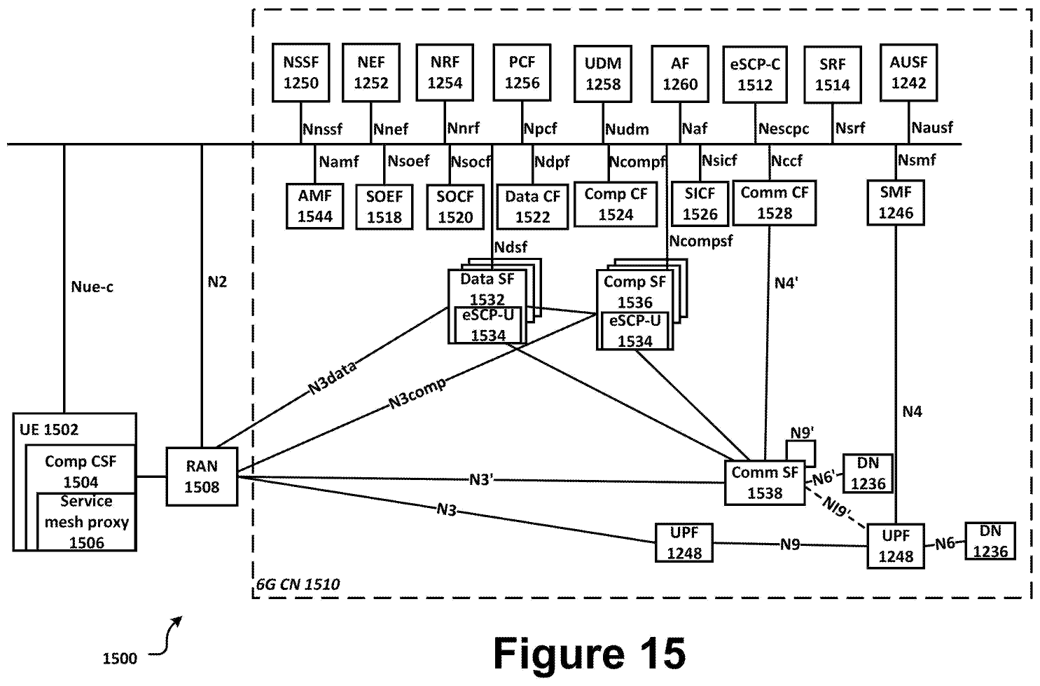

FIG. 15 illustrates a network 1500 in accordance with various embodiments. The network 1500 may operate in a matter consistent with 3GPP technical specifications or technical reports for 6G systems. In some embodiments, the network 1500 may operate concurrently with network 1200. For example, in some embodiments, the network 1500 may share one or more frequency or bandwidth resources with network 1200. As one specific example, a UE (e.g., UE 1502) may be configured to operate in both network 1500 and network 1200. Such configuration may be based on a UE including circuitry configured for communication with frequency and bandwidth resources of both networks 1200 and 1500. In general, several elements of network 1500 may share one or more characteristics with elements of network 1200. For the sake of brevity and clarity, such elements may not be repeated in the description of network 1500.

The network 1500 may include a UE 1502, which may include any mobile or non-mobile computing device designed to communicate with a RAN 1508 via an over-the-air connection. The UE 1502 may be similar to, for example, UE 1202. The UE 1502 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 15, in some embodiments the network 1500 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 15, the UE 1502 may be communicatively coupled with an AP such as AP 1206 as described with respect to FIG. 12. Additionally, although not specifically shown in FIG. 15, in some embodiments the RAN 1508 may include one or more ANss such as AN 1208 as described with respect to FIG. 12. The RAN 1508 and/or the AN of the RAN 1508 may be referred to as a base station (BS), a RAN node, or using some other term or name.

The UE 1502 and the RAN 1508 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1508 may allow for communication between the UE 1502 and a 6G core network (CN) 1510. Specifically, the RAN 1508 may facilitate the transmission and reception of data between the UE 1502 and the 6G CN 1510. The 6G CN 1510 may include various functions such as NSSF 1250, NEF 1252, NRF 1254, PCF 1256, UDM 1258, AF 1260, SMF 1246, and AUSF 1242. The 6G CN 1510 may additional include UPF 1248 and DN 1236 as shown in FIG. 15.

Additionally, the RAN 1508 may include various additional functions that are in addition to, or alternative to, functions of a legacy cellular network such as a 4G or 5G network. Two such functions may include a Compute Control Function (Comp CF) 1524 and a Compute Service Function (Comp SF) 1536. The Comp CF 1524 and the Comp SF 1536 may be parts or functions of the Computing Service Plane. Comp CF 1524 may be a control plane function that provides functionalities such as management of the Comp SF 1536, computing task context generation and management (e.g., create, read, modify, delete), interaction with the underlaying computing infrastructure for computing resource management, etc. Comp SF 1536 may be a user plane function that serves as the gateway to interface computing service users (such as UE 1502) and computing nodes behind a Comp SF instance. Some functionalities of the Comp SF 1536 may include: parse computing service data received from users to compute tasks executable by computing nodes; hold service mesh ingress gateway or service API gateway; service and charging policies enforcement; performance monitoring and telemetry collection, etc. In some embodiments, a Comp SF 1536 instance may serve as the user plane gateway for a cluster of computing nodes. A Comp CF 1524 instance may control one or more Comp SF 1536 instances.

Two other such functions may include a Communication Control Function (Comm CF) 1528 and a Communication Service Function (Comm SF) 1538, which may be parts of the Communication Service Plane. The Comm CF 1528 may be the control plane function for managing the Comm SF 1538, communication sessions creation/configuration/releasing, and managing communication session context. The Comm SF 1538 may be a user plane function for data transport. Comm CF 1528 and Comm SF 1538 may be considered as upgrades of SMF 1246 and UPF 1248, which were described with respect to a 5G system in FIG. 12. The upgrades provided by the Comm CF 1528 and the Comm SF 1538 may enable service-aware transport. For legacy (e.g., 4G or 5G) data transport, SMF 1246 and UPF 1248 may still be used.

Two other such functions may include a Data Control Function (Data CF) 1522 and Data Service Function (Data SF) 1532 may be parts of the Data Service Plane. Data CF 1522 may be a control plane function and provides functionalities such as Data SF 1532 management, Data service creation/configuration/releasing, Data service context management, etc. Data SF 1532 may be a user plane function and serve as the gateway between data service users (such as UE 1502 and the various functions of the 6G CN 1510) and data service endpoints behind the gateway. Specific functionalities may include: parse data service user data and forward to corresponding data service endpoints, generate charging data, report data service status.

Another such function may be the Service Orchestration and Chaining Function (SOCF) 1520, which may discover, orchestrate and chain up communication/computing/data services provided by functions in the network. Upon receiving service requests from users, SOCF 1520 may interact with one or more of Comp CF 1524, Comm CF 1528, and Data CF 1522 to identify Comp SF 1536, Comm SF 1538, and Data SF 1532 instances, configure service resources, and generate the service chain, which could contain multiple Comp SF 1536, Comm SF 1538, and Data SF 1532 instances and their associated computing endpoints. Workload processing and data movement may then be conducted within the generated service chain. The SOCF 1520 may also responsible for maintaining, updating, and releasing a created service chain.

Another such function may be the service registration function (SRF) 1514, which may act as a registry for system services provided in the user plane such as services provided by service endpoints behind Comp SF 1536 and Data SF 1532 gateways and services provided by the UE 1502. The SRF 1514 may be considered a counterpart of NRF 1254, which may act as the registry for network functions.

Other such functions may include an evolved service communication proxy (eSCP) and service infrastructure control function (SICF) 1526, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 1512 and eSCP-U 1534, for control plane service communication proxy and user plane service communication proxy, respectively. The SICF 1526 may control and configure eCSP instances in terms of service traffic routing policies, access rules, load balancing configurations, performance monitoring, etc.

Another such function is the AMF 1544. The AMF 1544 may be similar to 1244, but with additional functionality. Specifically, the AMF 1544 may include potential functional repartition, such as move the message forwarding functionality from the AMF 1544 to the RAN 1508.

Another such function is the service orchestration exposure function (SOEF) 1518. The SOEF may be configured to expose service orchestration and chaining services to external users such as applications.

The UE 1502 may include an additional function that is referred to as a computing client service function (comp CSF) 1504. The comp CSF 1504 may have both the control plane functionalities and user plane functionalities, and may interact with corresponding network side functions such as SOCF 1520, Comp CF 1524, Comp SF 1536, Data CF 1522, and/or Data SF 1532 for service discovery, request/response, compute task workload exchange, etc. The Comp CSF 1504 may also work with network side functions to decide on whether a computing task should be run on the UE 1502, the RAN 1508, and/or an element of the 6G CN 1510.

The UE 1502 and/or the Comp CSF 1504 may include a service mesh proxy 1506. The service mesh proxy 1506 may act as a proxy for service-to-service communication in the user plane. Capabilities of the service mesh proxy 1506 may include one or more of addressing, security, load balancing, etc.

### Example Procedures

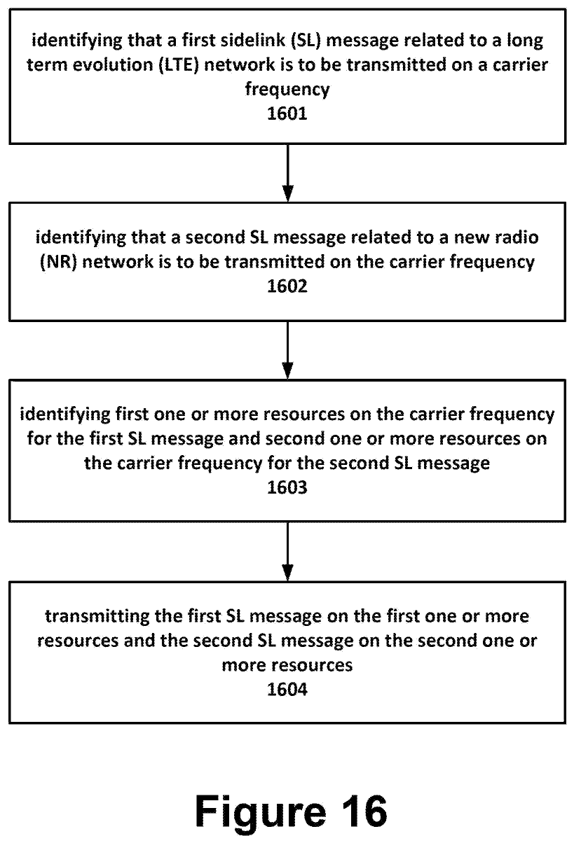

In some embodiments, the electronic device(s), network(s), system(s), chip(s) or component(s), or portions or implementations thereof, of FIGS. 12-15, or some other figure herein, may be configured to perform one or more processes, techniques, or methods as described herein, or portions thereof. One such process is depicted in FIG. 16. The process may relate to a method to be performed by a user equipment (UE), one or more elements of a UE, and/or an electronic device that includes or implements one or more elements of a UE. The process may include identifying, at 1601, that a first sidelink (SL) message related to a long term evolution (LTE) network is to be transmitted on a carrier frequency; identifying, at 1602, that a second SL message related to a new radio (NR) network is to be transmitted on the carrier frequency; identifying, at 1603, first one or more resources on the carrier frequency for the first SL message and second one or more resources on the carrier frequency for the second SL message; and transmitting, at 1604, the first SL message on the first one or more resources and the second SL message on the second one or more resources.

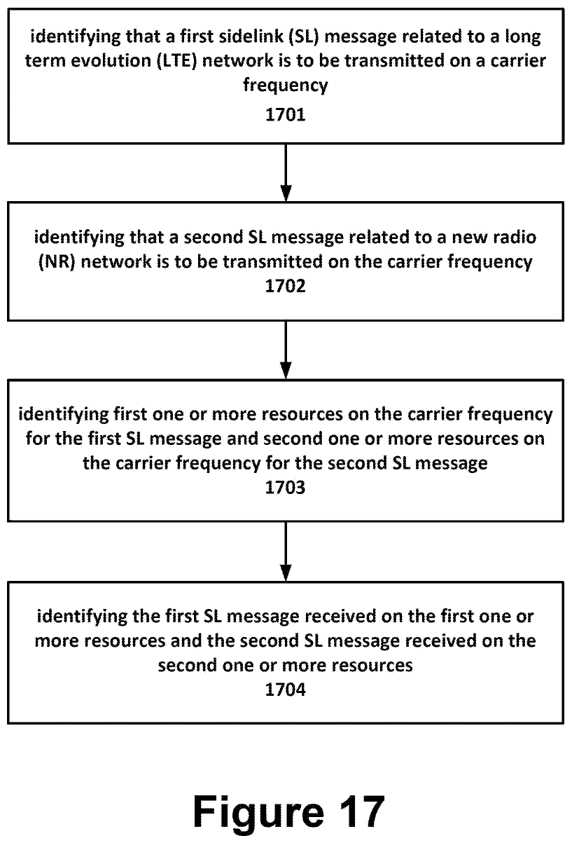

Another such process is depicted in FIG. 17. The process may relate to a method to be performed by a user equipment (UE), one or more elements of a UE, and/or an electronic device that includes or implements one or more elements of a UE. The process may include identifying, at 1701, that a first sidelink (SL) message related to a long term evolution (LTE) network is to be transmitted on a carrier frequency; identifying, at 1702, that a second SL message related to a new radio (NR) network is to be transmitted on the carrier frequency; identifying, at 1703, first one or more resources on the carrier frequency for the first SL message and second one or more resources on the carrier frequency for the second SL message; and identifying, at 1704, the first SL message received on the first one or more resources and the second SL message received on the second one or more resources.

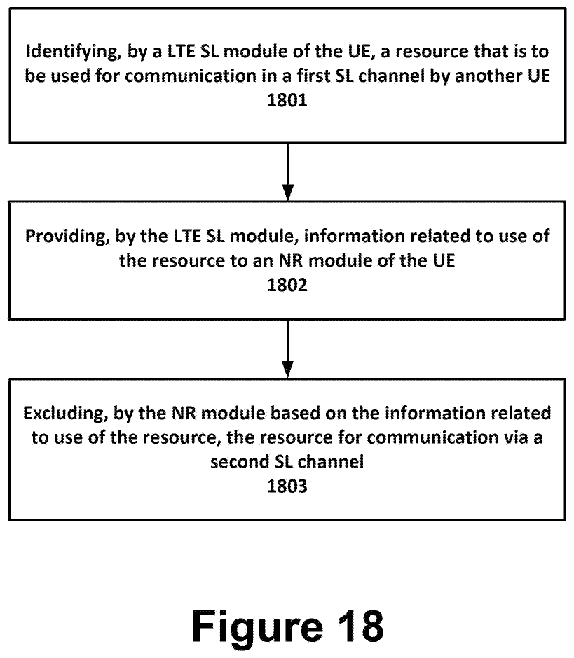

Another such process is depicted in FIG. 18. The process of FIG. 18 may relate to or include a method to be performed by a user equipment (UE). The process may include identifying, at 1801 by a long term evolution (LTE) sidelink (SL) module that is to facilitate communication via a first SL channel of a first cellular network, a resource that is to be used for communication in the first SL channel by another UE; providing, at 1802 by the LTE SL module, information related to use of the resource to a new radio (NR) SL module that is to facilitate communication via a second SL channel of a second cellular network; and excluding, at 1803 by the NR SL module based on the information related to use of the resource, the resource for communication via the second SL channel.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include the system and methods of wireless communication to allow co-existence between LTE and NR SL systems operating in the same carrier frequency.

Example 2 may include the method of example 1 or some other example herein, wherein a semi-static resource partitioning method is introduced.

Example 3 may include the method of example 1 or some other example herein, wherein methods allowing dynamic resource partitioning are introduced.

Example 4 may include the method of example 2 or some other example herein, wherein a resource selection method based on NR+LTE sensing and reserved resources and related details are introduced.

Example 5 may include the method of example 2 or some other example herein, wherein resource exclusion rules of LTE reserved resources and related details are introduced.

Example 6 may include the method of example 2 or some other example herein, wherein resource exclusion rules of LTE reserved resources based on the priority of the resources and related details are introduced.

Example 7 may include the method of example 2 or some other example herein, wherein a resource selection method based on LTE reserved resources and related details are introduced.

Example 8 may include the method of example 2 or some other example herein, wherein a dynamic TDD method between LTE and NR over a super-frame and related details are introduced.

Example 9 may include the method of example 2 or some other example herein, wherein a detect and avoid mechanism and related details are introduced.

Example 10 may include the method of example 2 or some other example herein, wherein an inter-UE coordination mechanism with exchange of information related to LTE reserved resources and related details are introduced.

Example 11 includes a method to be performed by a user equipment (UE), one or more elements of a UE, and/or an electronic device that includes or implements one or more elements of a UE, wherein the method comprises: identifying that a first sidelink (SL) message related to a long term evolution (LTE) network is to be transmitted on a carrier frequency; identifying that a second SL message related to a new radio (NR) network is to be transmitted on the carrier frequency; identifying first one or more resources on the carrier frequency for the first SL message and second one or more resources on the carrier frequency for the second SL message; and transmitting the first SL message on the first one or more resources and the second SL message on the second one or more resources.

Example 12 includes the method of example 11 and/or some other example herein, wherein the second SL message is to be transmitted on a physical SL feedback channel (PSFCH).

Example 13 includes the method of any of examples 11-12, and/or some other example herein, wherein the first or second one or more resources are identified based on semi-static resource partitioning or dynamic resource partitioning.

Example 14 includes the method of any of examples 11-13, and/or some other example herein, wherein the first or second one or more resources are identified based on NR+LTE sensing.

Example 15 includes the method of any of examples 11-14, and/or some other example herein, wherein the first one or more resources are orthogonal to the second one or more resources.

Example 16 includes a method to be performed by a user equipment (UE), one or more elements of a UE, and/or an electronic device that includes or implements one or more elements of a UE, wherein the method comprises: identifying that a first sidelink (SL) message related to a long term evolution (LTE) network is to be transmitted on a carrier frequency; identifying that a second SL message related to a new radio (NR) network is to be transmitted on the carrier frequency; identifying first one or more resources on the carrier frequency for the first SL message and second one or more resources on the carrier frequency for the second SL message; and identifying the first SL message received on the first one or more resources and the second SL message received on the second one or more resources.

Example 17 includes the method of example 16 and/or some other example herein, wherein the second SL message is to be transmitted on a physical SL feedback channel (PSFCH).

Example 18 includes the method of any of examples 16-17, and/or some other example herein, wherein the first or second one or more resources are identified based on semi-static resource partitioning or dynamic resource partitioning.

Example 19 includes the method of any of examples 16-18, and/or some other example herein, wherein the first or second one or more resources are identified based on NR+LTE sensing.

Example 20 includes the method of any of examples 16-19, and/or some other example herein, wherein the first one or more resources are orthogonal to the second one or more resources.

Example 21 includes the method of any of examples 11-20, wherein the first SL message and the second SL transmission are related to one or more of: shared time/frequency locations of reserved LTE transmissions; shared resource reservation periods; SL RSRP and/or SL RSSI measurement reports; and half-duplex subframes.

Example 22 includes a method to be performed by a user equipment (UE), wherein the method comprises: identifying, by a long term evolution (LTE) sidelink (SL) module that is to facilitate communication via a first SL channel of a first cellular network, a resource that is to be used for communication in the first SL channel by another UE; providing, by the LTE SL module, information related to use of the resource to a new radio (NR) SL module that is to facilitate communication via a second SL channel of a second cellular network; and excluding, by the NR SL module based on the information related to use of the resource, the resource for communication via the second SL channel.

Example 23 includes the method of example 22, and/or some other example herein, wherein the first cellular network is a LTE network and the second cellular network is a NR network.

Example 24 includes the method of any of examples 22-23, and/or some other example herein, wherein the information related to use of the resource includes information related to a time or frequency location of the resource.

Example 25 includes the method of any of examples 22-24, and/or some other example herein, wherein the information related to use of the resource includes information related to a resource reservation period of the resource.

Example 26 includes the method of any of examples 22-25, and/or some other example herein, wherein the information related to use of the resource includes information related to a quality measurement of the first SL channel.

Example 27 includes the method of example 26, and/or some other example herein, wherein the quality measurement is a reference signal received power (RSRP) measurement or a received signal strength indicator (RSSI) measurement.

Example 28 includes the method of example 26, and/or some other example herein, wherein the method further comprises excluding, by the NR module, the resource if a value related to the quality measurement is greater than a pre-identified value related to the quality measurement.

Example 29 includes the method of any of examples 22-28, and/or some other example herein, further comprising identifying, by the LTE SL module, the resource based on SL control information (SCI) received from the other UE.

Example 30 includes the method of any of examples 22-29, and/or some other example herein, wherein the communication via the second SL channel is a received physical SL feedback channel (PSFCH) transmission, and wherein the method further comprises excluding, by the NR module the resource by not transmitting a physical SL shared channel (PSSCH) transmission that would result in transmission of a PSFCH transmission that uses the resource.

Example 31 may include a user equipment (UE) comprising: a long term evolution (LTE) sidelink (SL) module to facilitate communication via a first SL channel of a first cellular network; and a new radio (NR) SL module to facilitate communication via a second SL channel of a second cellular network; wherein the LTE SL module is configured to: identify a resource that is to be used for communication in the first SL channel by another UE; and provide information related to use of the resource to the NR module; wherein the NR module is configured to exclude, based on the information related to use of the resource, the resource for communication via the second SL channel.

Example 32 may include the UE of example 31, and/or some other example herein, wherein the first cellular network is an LTE network and the second cellular network is a NR network.

Example 33 may include the method of any of examples 31-32, and/or some other example herein, wherein the information related to use of the resource includes information related to a time or frequency location of the resource.

Example 34 may include the method of any of examples 31-33, and/or some other example herein, wherein the information related to use of the resource includes information related to a resource reservation period of the resource.

Example 35 may include the UE of any of examples 31-34, and/or some other example herein, wherein the information related to use of the resource includes information related to a quality measurement of the first SL channel.

Example 36 may include the UE of example 35, and/or some other example herein, wherein the quality measurement is a reference signal received power (RSRP) measurement or a received signal strength indicator (RSSI) measurement.

Example 37 may include the UE of example 35, and/or some other example herein, wherein the NR module is to exclude the resource if a value related to the quality measurement is greater than a pre-identified value related to the quality measurement.

Example 38 may include the method of any of examples 31-37, and/or some other example herein, wherein the LTE SL module is configured to identify the resource based on SL control information (SCI) received from the other UE.

Example 39 may include the method of any of examples 31-38, and/or some other example herein, wherein the communication via the second SL channel is a received physical SL feedback channel (PSFCH) transmission, and wherein the NR module is to exclude the resource by not transmitting a physical SL shared channel (PSSCH) transmission that would result in transmission of a PSFCH transmission that uses the resource.

Example 40 may include a long term evolution (LTE) sidelink (SL) module for use in a user equipment (UE), wherein the LTE SL module is configured to: identify, based on SL control information (SCI) received from another UE, a resource that is to be used for communication in a first SL channel of an LTE network by the other UE; and provide information related to use of the resource to a new radio (NR) module of the UE, wherein the NR module is configured to exclude, based on the information related to use of the resource, the resource for communication via a second SL channel of a NR network.

Example 41 may include the LTE SL module of example 40, and/or some other example herein, wherein the information related to use of the resource includes information related to a time or frequency location of the resource.

Example 42 may include the LTE SL module of any of examples 40-41, and/or some other example herein, wherein the information related to use of the resource includes information related to a resource reservation period of the resource.

Example 43 may include the LTE SL module of any of examples 40-42, and/or some other example herein, wherein the information related to use of the resource includes information related to a quality measurement of the first SL channel.

Example 44 may include the LTE SL module of example 43, and/or some other example herein, wherein the quality measurement is a reference signal received power (RSRP) measurement or a received signal strength indicator (RSSI) measurement.

Example 45 may include the LTE SL module of example 43, and/or some other example herein, wherein the NR module is to exclude the resource if a value related to the quality measurement is greater than a pre-identified value related to the quality measurement.

Example 46 may include a new radio (NR) sidelink (SL) module for use in a user equipment (UE), wherein the NR SL module is configured to: identify, from a long term evolution (LTE) SL module of the UE based on SL control information (SCI) received from another UE, a resource that is to be used for communication in a first SL channel of an LTE network by the other UE; and exclude, based on the information related to use of the resource, the resource for communication via a second SL channel of a NR network.

Example 47 may include the NR SL module of example 46 LTE SL module, wherein the information related to use of the resource includes information related to a time or frequency location of the resource.

Example 48 may include the NR SL module of any of examples 46-47, and/or some other example herein, wherein the information related to use of the resource includes information related to a resource reservation period of the resource.

Example 49 may include the NR SL module of any of examples 46-48, and/or some other example herein, wherein the information related to use of the resource includes information related to a quality measurement of the first SL channel.

Example 50 may include the NR SL module of example 49, and/or some other example herein, wherein the NR module is to exclude the resource if a value related to the quality measurement is greater than a pre-identified value related to the quality measurement.

Example Z01 may include an apparatus comprising means to perform one or more elements of a method described in or related to any of examples 1-50, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-50, or any other method or process described herein.

Example Z03 may include an apparatus comprising logic, modules, or circuitry to perform one or more elements of a method described in or related to any of examples 1-50, or any other method or process described herein.

Example Z04 may include a method, technique, or process as described in or related to any of examples 1-50, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-50, or portions thereof.

Example Z06 may include a signal as described in or related to any of examples 1-50, or portions or parts thereof.

Example Z07 may include a datagram, packet, frame, segment, protocol data unit (PDU), or message as described in or related to any of examples 1-50, or portions or parts thereof, or otherwise described in the present disclosure.

Example Z08 may include a signal encoded with data as described in or related to any of examples 1-50, or portions or parts thereof, or otherwise described in the present disclosure.

Example Z09 may include a signal encoded with a datagram, packet, frame, segment, protocol data unit (PDU), or message as described in or related to any of examples 1-50, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-50, or portions thereof.

Example Z11 may include a computer program comprising instructions, wherein execution of the program by a processing element is to cause the processing element to carry out the method, techniques, or process as described in or related to any of examples 1-50, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019-06). For the purposes of the present document, the following abbreviations may apply to the examples and embodiments discussed herein.

3GPP Third Generation Partnership Project
4G Fourth Generation
5G Fifth Generation
5GC 5G Core network
AC Application Client
ACR Application Context Relocation
ACK Acknowledgement
ACID Application Client Identification
AF Application Function
AM Acknowledged Mode
AMBRAggregate Maximum Bit Rate
AMF Access and Mobility Management Function
AN Access Network
ANR Automatic Neighbour Relation
AOA Angle of Arrival
AP Application Protocol, Antenna Port, Access Point
API Application Programming Interface
APN Access Point Name
ARP Allocation and Retention Priority
ARQ Automatic Repeat Request
AS Access Stratum
ASP Application Service Provider
ASN.1 Abstract Syntax Notation One
AUSF Authentication Server Function
AWGN Additive White Gaussian Noise
BAP Backhaul Adaptation Protocol
BCH Broadcast Channel
BER Bit Error Ratio
BFD Beam Failure Detection
BLER Block Error Rate
BPSK Binary Phase Shift Keying
BRAS Broadband Remote Access Server
BSS Business Support System
BS Base Station
BSR Buffer Status Report
BW Bandwidth
BWP Bandwidth Part
C-RNTI Cell Radio Network Temporary Identity
CA Carrier Aggregation, Certification Authority
CAPEX CAPital Expenditure
CBD Candidate Beam Detection
CBRA Contention Based Random Access
CC Component Carrier, Country Code, Cryptographic Checksum
CCA Clear Channel Assessment
CCE Control Channel Element
CCCH Common Control Channel
CE Coverage Enhancement
CDM Content Delivery Network
CDMA Code-Division Multiple Access
CDR Charging Data Request
CDR Charging Data Response
CFRA Contention Free Random Access
CG Cell Group
CGF Charging Gateway Function
CHF Charging Function
CI Cell Identity
CID Cell-ID (e.g., positioning method)
CIM Common Information Model
CIR Carrier to Interference Ratio
CK Cipher Key
CM Connection Management, Conditional Mandatory
CMAS Commercial Mobile Alert Service
CMD Command
CMS Cloud Management System
CO Conditional Optional
CoMP Coordinated Multi-Point
CORESET Control Resource Set
COTS Commercial Off-The-Shelf
CP Control Plane, Cyclic Prefix, Connection Point
CPD Connection Point Descriptor
CPE Customer Premise Equipment
CPICHCommon Pilot Channel
CQI Channel Quality Indicator
CPU CSI processing unit, Central Processing Unit
C/R Command/Response field bit
CRAN Cloud Radio Access Network, Cloud RAN
CRB Common Resource Block
CRC Cyclic Redundancy Check
CRI Channel-State Information Resource Indicator,
CSI-RS Resource Indicator
C-RNTI Cell RNTI
CS Circuit Switched
CSCF call session control function
CSAR Cloud Service Archive
CSI Channel-State Information
CSI-IM CSI Interference Measurement
CSI-RS CSI Reference Signal
CSI-RSRP CSI reference signal received power
CSI-RSRQ CSI reference signal received quality
CSI-SINR CSI signal-to-noise and interference ratio
CSMA Carrier Sense Multiple Access
CSMA/CA CSMA with collision avoidance
CSS Common Search Space, Cell-specific Search Space
CTF Charging Trigger Function
CTS Clear-to-Send
CW Codeword
CWS Contention Window Size
D2D Device-to-Device
DC Dual Connectivity, Direct Current
DCI Downlink Control Information
DF Deployment Flavour
DL Downlink
DMTF Distributed Management Task Force
DPDK Data Plane Development Kit
DM-RS, DMRS Demodulation Reference Signal
DN Data network
DNN Data Network Name
DNAI Data Network Access Identifier
DRB Data Radio Bearer
DRS Discovery Reference Signal
DRX Discontinuous Reception
DSL Domain Specific Language. Digital Subscriber Line
DSLAM DSL Access Multiplexer
DwPTS Downlink Pilot Time Slot
E-LAN Ethernet Local Area Network
E2E End-to-End
EAS Edge Application Server
ECCA extended clear channel assessment, extended CCA
ECCE Enhanced Control Channel Element, Enhanced CCE
ED Energy Detection
EDGE Enhanced Datarates for GSM Evolution (GSM Evolution)
EAS Edge Application Server
EASID Edge Application Server Identification
ECS Edge Configuration Server
ECSP Edge Computing Service Provider
EDN Edge Data Network
EEC Edge Enabler Client
EECID Edge Enabler Client Identification
EES Edge Enabler Server
EESID Edge Enabler Server Identification
EHE Edge Hosting Environment
EGMF Exposure Governance Management Function
EGPRS Enhanced GPRS
EIR Equipment Identity Register
eLAA enhanced Licensed Assisted Access, enhanced LAA
EM Element Manager
eMBB Enhanced Mobile Broadband
EMS Element Management System
eNB evolved NodeB, E-UTRAN Node B
EN-DC E-UTRA-NR Dual Connectivity
EPC Evolved Packet Core
EPDCCH enhanced PDCCH, enhanced Physical Downlink Control Cannel
EPRE Energy per resource element
EPS Evolved Packet System
EREG enhanced REG, enhanced resource element groups
ETSI European Telecommunications Standards Institute
ETWS Earthquake and Tsunami Warning System
eUICC embedded UICC, embedded Universal Integrated Circuit Card
E-UTRA Evolved UTRA
E-UTRAN Evolved UTRAN
EV2X Enhanced V2X
F1AP F1 Application Protocol
F1-C F1 Control plane interface
F1-U F1 User plane interface
FACCH Fast Associated Control CHannel
FACCH/F Fast Associated Control Channel/Full rate
FACCH/H Fast Associated Control Channel/Half rate
FACH Forward Access Channel
FAUSCH Fast Uplink Signalling Channel
FB Functional Block
FBI Feedback Information
FCC Federal Communications Commission
FCCH Frequency Correction CHannel
FDD Frequency Division Duplex
FDM Frequency Division Multiplex
FDMAFrequency Division Multiple Access
FE Front End
FEC Forward Error Correction
FFS For Further Study
FFT Fast Fourier Transformation
feLAA further enhanced Licensed Assisted Access, further enhanced LAA
FN Frame Number
FPGA Field-Programmable Gate Array
FR Frequency Range
FQDN Fully Qualified Domain Name
G-RNTI GERAN Radio Network Temporary Identity
GERAN GSM EDGE RAN, GSM EDGE Radio Access Network
GGSN Gateway GPRS Support Node
GLONASS GLObal’naya NAvigatsionnaya Sputnikovaya Sistema
(Engl.: Global Navigation Satellite System)
gNB Next Generation NodeB
gNB-CU gNB-centralized unit, Next Generation NodeB centralized unit
gNB-DU gNB-distributed unit, Next Generation NodeB distributed unit
GNSS Global Navigation Satellite System
GPRS General Packet Radio Service
GPSI Generic Public Subscription Identifier
GSM Global System for Mobile Communications, Groupe Spécial Mobile
GTP GPRS Tunneling Protocol
GTP-UGPRS Tunnelling Protocol for User Plane
GTS Go To Sleep Signal (related to WUS)
GUMMEI Globally Unique MME Identifier
GUTI Globally Unique Temporary UE Identity
HARQ Hybrid ARQ, Hybrid Automatic Repeat Request
HANDO Handover
HFN HyperFrame Number
HHO Hard Handover
HLR Home Location Register
HN Home Network
HO Handover
HPLMN Home Public Land Mobile Network
HSDPA High Speed Downlink Packet Access
HSN Hopping Sequence Number
HSPA High Speed Packet Access
HSS Home Subscriber Server
HSUPA High Speed Uplink Packet Access
HTTP Hyper Text Transfer Protocol
HTTPS Hyper Text Transfer Protocol Secure
(https is http/1.1 over SSL, i.e. port 443)
I-Block Information Block
ICCID Integrated Circuit Card Identification
IAB Integrated Access and Backhaul
ICIC Inter-Cell Interference Coordination
ID Identity, identifier
IDFT Inverse Discrete Fourier Transform
IE Information element
IBE In-Band Emission
IEEE Institute of Electrical and Electronics Engineers
IEI Information Element Identifier
IEIDL Information Element Identifier Data Length
IETF Internet Engineering Task Force
IF Infrastructure
IIOT Industrial Internet of Things
IM Interference Measurement, Intermodulation, IP Multimedia
IMC IMS Credentials
IMEI International Mobile Equipment Identity
IMGI International mobile group identity
IMPI IP Multimedia Private Identity
IMPU IP Multimedia PUblic identity
IMS IP Multimedia Subsystem
IMSI International Mobile Subscriber Identity
IoT Internet of Things
IP Internet Protocol
Ipsec IP Security, Internet Protocol Security
IP-CAN IP-Connectivity Access Network
IP-M IP Multicast
IPv4 Internet Protocol Version 4
IPv6 Internet Protocol Version 6
IR Infrared
IS In Sync
IRP Integration Reference Point
ISDN Integrated Services Digital Network
ISIM IM Services Identity Module
ISO International Organisation for Standardisation
ISP Internet Service Provider
IWF Interworking-Function
I-WLAN Interworking WLAN
Constraint length of the convolutional code, USIM Individual key
kB Kilobyte (1000 bytes)
kbps kilo-bits per second
Kc Ciphering key
Ki Individual subscriber authentication key
KPI Key Performance Indicator
KQI Key Quality Indicator
KSI Key Set Identifier
ksps kilo-symbols per second
KVM Kernel Virtual Machine
L1 Layer 1 (physical layer)
L1-RSRP Layer 1 reference signal received power
L2 Layer 2 (data link layer)
L3 Layer 3 (network layer)
LAA Licensed Assisted Access
LAN Local Area Network
LADN Local Area Data Network
LBT Listen Before Talk
LCM LifeCycle Management
LCR Low Chip Rate
LCS Location Services
LCID Logical Channel ID
LI Layer Indicator
LLC Logical Link Control, Low Layer Compatibility
LMF Location Management Function
LOS Line of Sight
LPLMN Local PLMN
LPP LTE Positioning Protocol
LSB Least Significant Bit
LTE Long Term Evolution
LWA LTE-WLAN aggregation
LWIP LTE/WLAN Radio Level Integration with IPsec Tunnel
LTE Long Term Evolution
M2M Machine-to-Machine
MAC Medium Access Control (protocol layering context)
MAC Message authentication code (security/encryption context)
MAC-A MAC used for authentication and key agreement
(TSG T WG3 context)
MAC-IMAC used for data integrity of signalling messages
(TSG T WG3 context)
MANO Management and Orchestration
MBMS Multimedia Broadcast and Multicast Service
MBSFN Multimedia Broadcast multicast service
Single Frequency Network
MCC Mobile Country Code
MCG Master Cell Group
MCOTMaximum Channel Occupancy Time
MCS Modulation and coding scheme
MDAF Management Data Analytics Function
MDAS Management Data Analytics Service
MDT Minimization of Drive Tests
ME Mobile Equipment
MeNB master eNB
MER Message Error Ratio
MGL Measurement Gap Length
MGRP Measurement Gap Repetition Period
MIB Master Information Block, Management Information Base
MIMO Multiple Input Multiple Output
MLC Mobile Location Centre
MM Mobility Management
MME Mobility Management Entity
MN Master Node
MNO Mobile Network Operator
MO Measurement Object, Mobile Originated
MPBCH MTC Physical Broadcast CHannel
MPDCCH MTC Physical Downlink Control CHannel
MPDSCH MTC Physical Downlink Shared CHannel
MPRACH MTC Physical Random Access CHannel
MPUSCH MTC Physical Uplink Shared Channel
MPLS MultiProtocol Label Switching
MS Mobile Station
MSB Most Significant Bit
MSC Mobile Switching Centre
MSI Minimum System Information,
MCH Scheduling Information
MSID Mobile Station Identifier
MSIN Mobile Station Identification Number
MSISDN Mobile Subscriber ISDN Number
MT Mobile Terminated, Mobile Termination
MTC Machine-Type Communications
mMTCmassive MTC, massive Machine-Type Communications
MU-MIMO Multi User MIMO
MWUS MTC wake-up signal, MTC WUS
NACK Negative Acknowledgement
NAI Network Access Identifier
NAS Non-Access Stratum, Non- Access Stratum layer
NCT Network Connectivity Topology
NC-JT Non-Coherent Joint Transmission
NEC Network Capability Exposure
NE-DC NR-E-UTRA Dual Connectivity
NEF Network Exposure Function
NF Network Function
NFP Network Forwarding Path
NFPD Network Forwarding Path Descriptor
NFV Network Functions Virtualization
NFVI NFV Infrastructure
NFVO NFV Orchestrator
NG Next Generation, Next Gen
NGEN-DC NG-RAN E-UTRA-NR Dual Connectivity
NM Network Manager
NMS Network Management System
N-PoP Network Point of Presence
NMIB, N-MIB Narrowband MIB
NPBCH Narrowband Physical Broadcast CHannel
NPDCCH Narrowband Physical Downlink Control CHannel
NPDSCH Narrowband Physical Downlink Shared CHannel
NPRACH Narrowband Physical Random Access CHannel
NPUSCH Narrowband Physical Uplink Shared CHannel
NPSS Narrowband Primary Synchronization Signal
NSSS Narrowband Secondary Synchronization Signal
NR New Radio, Neighbour Relation
NRF NF Repository Function
NRS Narrowband Reference Signal
NS Network Service
NSA Non-Standalone operation mode
NSD Network Service Descriptor
NSR Network Service Record
NSSAINetwork Slice Selection Assistance Information
S-NNSAI Single-NSSAI
NSSF Network Slice Selection Function
NW Network
NWUSNarrowband wake-up signal, Narrowband WUS
NZP Non-Zero Power
O&M Operation and Maintenance
ODU2 Optical channel Data Unit - type 2
OFDM Orthogonal Frequency Division Multiplexing
OFDMA Orthogonal Frequency Division Multiple Access
OOB Out-of-Band
OOS Out of Sync
OPEX OPerating EXpense
OSI Other System Information
OSS Operations Support System
OTA over-the-air
PAPR Peak-to-Average Power Ratio
PAR Peak to Average Ratio
PBCH Physical Broadcast Channel
PC Power Control, Personal Computer
PCC Primary Component Carrier, Primary CC
P-CSCF Proxy CSCF
PCell Primary Cell
PCI Physical Cell ID, Physical Cell Identity
PCEF Policy and Charging Enforcement Function
PCF Policy Control Function
PCRF Policy Control and Charging Rules Function
PDCP Packet Data Convergence Protocol,
Packet Data Convergence Protocol layer
PDCCH Physical Downlink Control Channel
PDCP Packet Data Convergence Protocol
PDN Packet Data Network, Public Data Network
PDSCH Physical Downlink Shared Channel
PDU Protocol Data Unit
PEI Permanent Equipment Identifiers
PFD Packet Flow Description
P-GW PDN Gateway
PHICH Physical hybrid-ARQ indicator channel
PHY Physical layer
PLMN Public Land Mobile Network
PIN Personal Identification Number
PM Performance Measurement
PMI Precoding Matrix Indicator
PNF Physical Network Function
PNFD Physical Network Function Descriptor
PNFR Physical Network Function Record
POC PTT over Cellular
PP, PTP Point-to-Point
PPP Point-to-Point Protocol
PRACH Physical RACH
PRB Physical resource block
PRG Physical resource block group
ProSe Proximity Services, Proximity-Based Service
PRS Positioning Reference Signal
PRR Packet Reception Radio
PS Packet Services
PSBCH Physical Sidelink Broadcast Channel
PSDCH Physical Sidelink Downlink Channel
PSCCH Physical Sidelink Control Channel
PSSCH Physical Sidelink Shared Channel
PSFCH physical sidelink feedback channel
PSCell Primary SCell
PSS Primary Synchronization Signal
PSTN Public Switched Telephone Network
PT-RS Phase-tracking reference signal
PTT Push-to-Talk
PUCCH Physical Uplink Control Channel
PUSCH Physical Uplink Shared Channel
QAM Quadrature Amplitude Modulation
QCI QoS class of identifier
QCL Quasi co-location
QFI QoS Flow ID, QoS Flow Identifier
QoS Quality of Service
QPSK Quadrature (Quarternary) Phase Shift Keying
QZSS Quasi-Zenith Satellite System
RA-RNTI Random Access RNTI
RAB Radio Access Bearer, Random Access Burst
RACH Random Access Channel
RADIUS Remote Authentication Dial In User Service
RAN Radio Access Network
RAND RANDom number (used for authentication)
RAR Random Access Response
RAT Radio Access Technology
RAU Routing Area Update
RB Resource block, Radio Bearer
RBG Resource block group
REG Resource Element Group
Rel Release
REQ REQuest
RF Radio Frequency
RI Rank Indicator
RIV Resource indicator value
RL Radio Link
RLC Radio Link Control, Radio Link Control layer
RLC AM RLC Acknowledged Mode
RLC UM RLC Unacknowledged Mode
RLF Radio Link Failure
RLM Radio Link Monitoring
RLM-RS Reference Signal for RLM
RM Registration Management
RMC Reference Measurement Channel
RMSI Remaining MSI, Remaining Minimum System Information
RN Relay Node
RNC Radio Network Controller
RNL Radio Network Layer
RNTI Radio Network Temporary Identifier
ROHC RObust Header Compression
RRC Radio Resource Control, Radio Resource Control layer
RRM Radio Resource Management
RS Reference Signal
RSRP Reference Signal Received Power
RSRQ Reference Signal Received Quality
RSSI Received Signal Strength Indicator
RSU Road Side Unit
RSTD Reference Signal Time difference
RTP Real Time Protocol
RTS Ready-To-Send
RTT Round Trip Time
Rx Reception, Receiving, Receiver
S1AP S1 Application Protocol
S1-MME S1 for the control plane
S1-U S1 for the user plane
S-CSCF serving CSCF
S-GW Serving Gateway
S-RNTI SRNC Radio Network Temporary Identity
S-TMSI SAE Temporary Mobile Station Identifier
SA Standalone operation mode
SAE System Architecture Evolution
SAP Service Access Point
SAPD Service Access Point Descriptor
SAPI Service Access Point Identifier
SCC Secondary Component Carrier, Secondary CC
SCell Secondary Cell
SCEF Service Capability Exposure Function
SC-FDMA Single Carrier Frequency Division Multiple Access
SCG Secondary Cell Group
SCM Security Context Management
SCS Subcarrier Spacing
SCTP Stream Control Transmission Protocol
SDAP Service Data Adaptation Protocol,
Service Data Adaptation Protocol layer
SDL Supplementary Downlink
SDNF Structured Data Storage Network Function
SDP Session Description Protocol
SDSF Structured Data Storage Function
SDT Small Data Transmission
SDU Service Data Unit
SEAF Security Anchor Function
SeNB secondary eNB
SEPP Security Edge Protection Proxy
SFI Slot format indication
SFTD Space-Frequency Time Diversity, SFN and frame timing difference
SFN System Frame Number
SgNB secondary gNB
SGSN Serving GPRS Support Node
S-GW Serving Gateway
SI System Information
SI-RNTI System Information RNTI
SIB System Information Block
SIM Subscriber Identity Module
SIP Session Initiated Protocol
SiP System in Package
SL Sidelink
SLA Service Level Agreement
SM Session Management
SMF Session Management Function
SMS Short Message Service
SMSF SMS Function
SMTC SSB-based Measurement Timing Configuration
SN Secondary Node, Sequence Number
SoC System on Chip
SON Self-Organizing Network
SpCell Special Cell
SP-CSI-RNTISemi-Persistent CSI RNTI
SPS Semi-Persistent Scheduling
SQN Sequence number
SR Scheduling Request
SRB Signalling Radio Bearer
SRS Sounding Reference Signal
SS Synchronization Signal
SSB Synchronization Signal Block
SSID Service Set Identifier
SS/PBCH Block SSBRI SS/PBCH Block Resource Indicator,
Synchronization Signal Block Resource Indicator
SSC Session and Service Continuity
SS-RSRP Synchronization Signal based Reference Signal
Received Power
SS-RSRQ Synchronization Signal based Reference Signal
Received Quality
SS-SINR Synchronization Signal based Signal to Noise
and Interference Ratio
SSS Secondary Synchronization Signal
SSSG Search Space Set Group
SSSIF Search Space Set Indicator
SST Slice/Service Types
SU-MIMO Single User MIMO
SUL Supplementary Uplink
TA Timing Advance, Tracking Area
TAC Tracking Area Code
TAG Timing Advance Group
TAI Tracking Area Identity
TAU Tracking Area Update
TB Transport Block
TBS Transport Block Size
TBD To Be Defined
TCI Transmission Configuration Indicator
TCP Transmission Communication Protocol
TDD Time Division Duplex
TDM Time Division Multiplexing
TDMATime Division Multiple Access
TE Terminal Equipment
TEID Tunnel End Point Identifier
TFT Traffic Flow Template
TMSI Temporary Mobile Subscriber Identity
TNL Transport Network Layer
TPC Transmit Power Control
TPMI Transmitted Precoding Matrix Indicator
TR Technical Report
TRP, TRxP Transmission Reception Point
TRS Tracking Reference Signal
TRx Transceiver
TS Technical Specifications, Technical Standard
TTI Transmission Time Interval
Tx Transmission, Transmitting, Transmitter
U-RNTI UTRAN Radio Network Temporary Identity
UART Universal Asynchronous Receiver and Transmitter
UCI Uplink Control Information
UE User Equipment
UDM Unified Data Management
UDP User Datagram Protocol
USDF Unstructured Data Storage Network Function
UICC Universal Integrated Circuit Card
UL Uplink
UM Unacknowledged Mode
UML Unified Modelling Language
UMTS Universal Mobile Telecommunications System
UP User Plane
UPF User Plane Function
URI Uniform Resource Identifier
URL Uniform Resource Locator
URLLC Ultra-Reliable and Low Latency
USB Universal Serial Bus
USIM Universal Subscriber Identity Module
USS UE-Specific search space
UTRA UMTS Terrestrial Radio Access
UTRAN Universal Terrestrial Radio Access Network
UwPTS Uplink Pilot Time Slot
V2I Vehicle-to-Infrastruction
V2P Vehicle-to-Pedestrian
V2V Vehicle-to-Vehicle
V2X Vehicle-to-everything
VIM Virtualized Infrastructure Manager
VL Virtual Link,
VLAN Virtual LAN, Virtual Local Area Network
VM Virtual Machine
VNF Virtualized Network Function
VNFFG VNF Forwarding Graph
VNFFGD VNF Forwarding Graph Descriptor
VNFM VNF Manager
VoIP Voice-over-IP, Voice-over- Internet Protocol
VPLMN Visited Public Land Mobile Network
VPN Virtual Private Network
VRB Virtual Resource Block
WiMAX Worldwide Interoperability for Microwave Access
WLANWireless Local Area Network
WMAN Wireless Metropolitan Area Network
WPANWireless Personal Area Network
X2-C X2-Control plane
X2-U X2-User plane
XML eXtensible Markup Language
XRES EXpected user RESponse
XOR eXclusive OR
ZC Zadoff-Chu
ZP Zero Power

### Terminology

For the purposes of the present document, the following terms and definitions are applicable to the examples and embodiments discussed herein.

The term “application” may refer to a complete and deployable package, environment to achieve a certain function in an operational environment. The term “AI/ML application” or the like may be an application that contains some AI/ML models and application-level descriptions.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

The term “machine learning” or “ML” refers to the use of computer systems implementing algorithms and/or statistical models to perform specific task(s) without using explicit instructions, but instead relying on patterns and inferences. ML algorithms build or estimate mathematical model(s) (referred to as “ML models” or the like) based on sample data (referred to as “training data,” “model training information,” or the like) in order to make predictions or decisions without being explicitly programmed to perform such tasks. Generally, an ML algorithm is a computer program that learns from experience with respect to some task and some performance measure, and an ML model may be any object or data structure created after an ML algorithm is trained with one or more training datasets. After training, an ML model may be used to make predictions on new datasets. Although the term “ML algorithm” refers to different concepts than the term “ML model,” these terms as discussed herein may be used interchangeably for the purposes of the present disclosure.

The term “machine learning model,” “ML model,” or the like may also refer to ML methods and concepts used by an ML-assisted solution. An “ML-assisted solution” is a solution that addresses a specific use case using ML algorithms during operation. ML models include supervised learning (e.g., linear regression, k-nearest neighbor (KNN), decision tree algorithms, support machine vectors, Bayesian algorithm, ensemble algorithms, etc.) unsupervised learning (e.g., K-means clustering, principle component analysis (PCA), etc.), reinforcement learning (e.g., Q-learning, multi-armed bandit learning, deep RL, etc.), neural networks, and the like. Depending on the implementation a specific ML model could have many sub-models as components and the ML model may train all sub-models together. Separately trained ML models can also be chained together in an ML pipeline during inference. An “ML pipeline” is a set of functionalities, functions, or functional entities specific for an ML-assisted solution; an ML pipeline may include one or several data sources in a data pipeline, a model training pipeline, a model evaluation pipeline, and an actor. The “actor” is an entity that hosts an ML assisted solution using the output of the ML model inference). The term “ML training host” refers to an entity, such as a network function, that hosts the training of the model. The term “ML inference host” refers to an entity, such as a network function, that hosts model during inference mode (which includes both the model execution as well as any online learning if applicable). The ML-host informs the actor about the output of the ML algorithm, and the actor takes a decision for an action (an “action” is performed by an actor as a result of the output of an ML assisted solution). The term “model inference information” refers to information used as an input to the ML model for determining inference(s); the data used to train an ML model and the data used to determine inferences may overlap, however, “training data” and “inference data” refer to different concepts.

1.-20. (canceled)

21. A user equipment (UE) comprising:
a long term evolution (LTE) sidelink (SL) module to facilitate communication via a first SL channel of a first cellular network; and
a new radio (NR) SL module to facilitate communication via a second SL channel of a second cellular network;
wherein the LTE SL module is configured to:
identify a resource that is to be used for communication in the first SL channel by another UE; and
provide information related to use of the resource to the NR module;
wherein the NR module is configured to exclude, based on the information related to use of the resource, the resource for communication via the second SL channel.

22. The UE of claim 21, wherein the first cellular network is an LTE network and the second cellular network is a NR network.

23. The UE of claim 21, wherein the information related to use of the resource includes information related to a time or frequency location of the resource.

24. The UE of claim 21, wherein the information related to use of the resource includes information related to a resource reservation period of the resource.

25. The UE of claim 21, wherein the information related to use of the resource includes information related to a quality measurement of the first SL channel.

26. The UE of claim 25, wherein the quality measurement is a reference signal received power (RSRP) measurement or a received signal strength indicator (RSSI) measurement.

27. The UE of claim 25, wherein the NR module is to exclude the resource if a value related to the quality measurement is greater than a pre-identified value related to the quality measurement.

28. The UE of claim 21, wherein the LTE SL module is configured to identify the resource based on SL control information (SCI) received from the other UE.

29. The UE of claim 21, wherein the communication via the second SL channel is a received physical SL feedback channel (PSFCH) transmission, and wherein the NR module is to exclude the resource by not transmitting a physical SL shared channel (PSSCH) transmission that would result in transmission of a PSFCH transmission that uses the resource.

30. A long term evolution (LTE) sidelink (SL) module for use in a user equipment (UE), wherein the LTE SL module is configured to:
identify, based on SL control information (SCI) received from another UE, a resource that is to be used for communication in a first SL channel of an LTE network by the other UE; and
provide information related to use of the resource to a new radio (NR) module of the UE, wherein the NR module is configured to exclude, based on the information related to use of the resource, the resource for communication via a second SL channel of a NR network.

31. The LTE SL module of claim 30, wherein the information related to use of the resource includes information related to a time or frequency location of the resource.

32. The LTE SL module of claim 30, wherein the information related to use of the resource includes information related to a resource reservation period of the resource.

33. The LTE SL module of claim 30, wherein the information related to use of the resource includes information related to a quality measurement of the first SL channel.

34. The LTE SL module of claim 33, wherein the quality measurement is a reference signal received power (RSRP) measurement or a received signal strength indicator (RSSI) measurement.

35. The LTE SL module of claim 33, wherein the NR module is to exclude the resource if a value related to the quality measurement is greater than a pre-identified value related to the quality measurement.

36. A new radio (NR) sidelink (SL) module for use in a user equipment (UE), wherein the NR SL module is configured to:
identify, from a long term evolution (LTE) SL module of the UE based on SL control information (SCI) received from another UE, a resource that is to be used for communication in a first SL channel of an LTE network by the other UE; and
exclude, based on the information related to use of the resource, the resource for communication via a second SL channel of a NR network.

37. The NR SL module of claim 36, wherein the information related to use of the resource includes information related to a time or frequency location of the resource.

38. The NR SL module of claim 36, wherein the information related to use of the resource includes information related to a resource reservation period of the resource.

39. The NR SL module of claim 36, wherein the information related to use of the resource includes information related to a quality measurement of the first SL channel.

40. The NR SL module of claim 39, wherein the NR module is to exclude the resource if a value related to the quality measurement is greater than a pre-identified value related to the quality measurement.
